(19) United States
(12) Patent Application Publication
(10) Pub. No.: US 2025/0001597 A1
(43) Pub. Date: Jan. 2, 2025

(54) COLLABORATIVE HUMAN-ROBOT ERROR CORRECTION AND FACILITATION

(71) Applicant: Intel Corporation, Santa Clara, CA (US)

(72) Inventors: Javier Sebastian Turek, Beaverton, OR (US); Leobardo Campos Macias, Guadalajara (MX); Javier Felip Leon, Hillsboro, OR (US)

(21) Appl. No.: 18/344,526

(22) Filed: Jun. 29, 2023

(51) Int. Cl. B25J 9/16

(52) U.S. Cl. CPC B25J 9/1661; B25J 9/1653; B25J 9/1674

(57) ABSTRACT

Techniques are disclosed for task error correction for robots, such as collaborative robots (cobots). A controller of a robot may include an error detector to detect an error in a performance of a human-robot collaborative task, and an error corrector to correct the detected error. The error corrector may include a correction planner and a facilitator. The correction planner may determine an error correction plan based on the detected error. The error correction plan may include corrective subtasks to control the cobot to correct the detected error. The facilitator may determine a facilitation plan based on the determined error correction plan. The facilitation plan including an assistance subtask configured to control the cobot to assist a human operator in correcting the detected error. The error corrector may generate a control signal to control the cobot based on the correction plan and the facilitation plan.

### TECHNICAL FIELD

The disclosure generally relates to error correction in human-robot environments, including the collaboration between humans and collaborative robots for error correction and the facilitation of error correction in shared environments.

### BACKGROUND

Autonomous agents, such as collaborative robots (cobots) may be deployed to complement humans in performing tasks in a working environment (e.g., workbench spaces). In such human-robot shared working environments, humans may collaborate with robots to solve tasks with a shared objective. Humans are known to be more cognizant and flexible to solve tasks in such environments, while robots may provide more precisions, quality, safety, and/or repeatability. These collaborative settings advantageously provide highly flexible uses, where robot-only configurations may be overly difficult or expensive to implement and human-only configurations may be ineffective.

However, such flexibility and the human factor may introduce uncertainty and impact the quality of the completed tasks because humans (as well as cobots) are prone to errors in environments with increased flexibility. Further, while the programmable nature of cobots may allow for a more immediate detection of failures or errors during a subtask, conventional error detection is limited in the type and scope of detectable errors, including being limited to detecting errors caused by the robot due the variability and unpredictability of human actions (e.g., each human is different and may proceed differently each time). These error-detection limitations may result in quality degradation due to one or more unexpected decisions.

### BRIEF DESCRIPTION OF THE DRAWINGS/FIGURES

The accompanying drawings, which are incorporated herein and form a part of the specification, illustrate the present disclosure and, together with the description, and further serve to explain the principles of the disclosure and to enable a person skilled in the pertinent art to make and use the techniques discussed herein.

FIG. 1 illustrates a block diagram of a human-robot collaborative environment according to the disclosure.

FIG. 2 illustrates a block diagram of an autonomous agent (e.g., cobot) according to the disclosure.

FIG. 3 illustrates a block diagram of a computing device (controller) according to the disclosure.

FIG. 4 illustrates an operational flowchart of a detection and correction method according to the disclosure.

FIG. 5 illustrates an operational flowchart of an error correction method according to the disclosure.

FIG. 6 illustrates a Directed Acyclic Graph (DAG) task action according to the disclosure.

FIG. 7 illustrates an operational flowchart of an error correction method and the insertion of a temporary subtask according to the disclosure.

FIG. 8 illustrates an operational flowchart of an error correction method including the facilitation of the error correction according to the disclosure

FIG. 9 illustrates an operational flowchart of a facilitation method according to the disclosure.

FIG. 10 illustrates a subtask action according to the disclosure.

The present disclosure will be described with reference to the accompanying drawings. The drawing in which an element first appears is typically indicated by the leftmost digit(s) in the corresponding reference number.

### DETAILED DESCRIPTION

The following detailed description refers to the accompanying drawings that show, by way of illustration, exemplary details in which the disclosure may be practiced. In the following description, numerous specific details are set forth in order to provide a thorough understanding of the present disclosure. However, it will be apparent to those skilled in the art that the various designs, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring the disclosure.

The present disclosure provides an advantageous solution to improve human-robot collaborations applicable in collaborative environments, such as workspaces or workbench spaces. The disclosure provides methods and systems to recover from human errors leveraging enhanced error detection of human errors by the robot. Based on the detected errors, cobot planning may be updated to correct the errors and/or to facilitate the correction of the error by the human operator by the robot assisting the human operator in the error correction. The error correction planner may compute an operational path to error correction using robot and human collaboration.

According to the disclosure, tasks may be continuously monitored following the task description, and when errors are detected, the planning system may compute actions required to correct the error and provide a warning to the human operator in real-time. This may include simultaneously solving task and motion planning (TAMP).

Autonomous agents, such as collaborative robots (cobots), are increasing being adapted for use in human-robot settings in, for example, factories, warehouses, hospitals, and other industrial and/or commercial environments. According to the disclosure, the system is configured to implement a correction planning and facilitation algorithm that provides the detection of human (and/or cobot) errors, and the correction of errors and/or the facilitation of error correction. Although the disclosure is described with respect to stationary autonomous agents, such as cobots, the disclosure is applicable to other autonomous agents, such as mobile agents (e.g., autonomous mobile robots (AMRs)). The disclosure is also applicable for error detection, error correction, and/or facilitation in larger environments, such as in autonomous vehicle implementations.

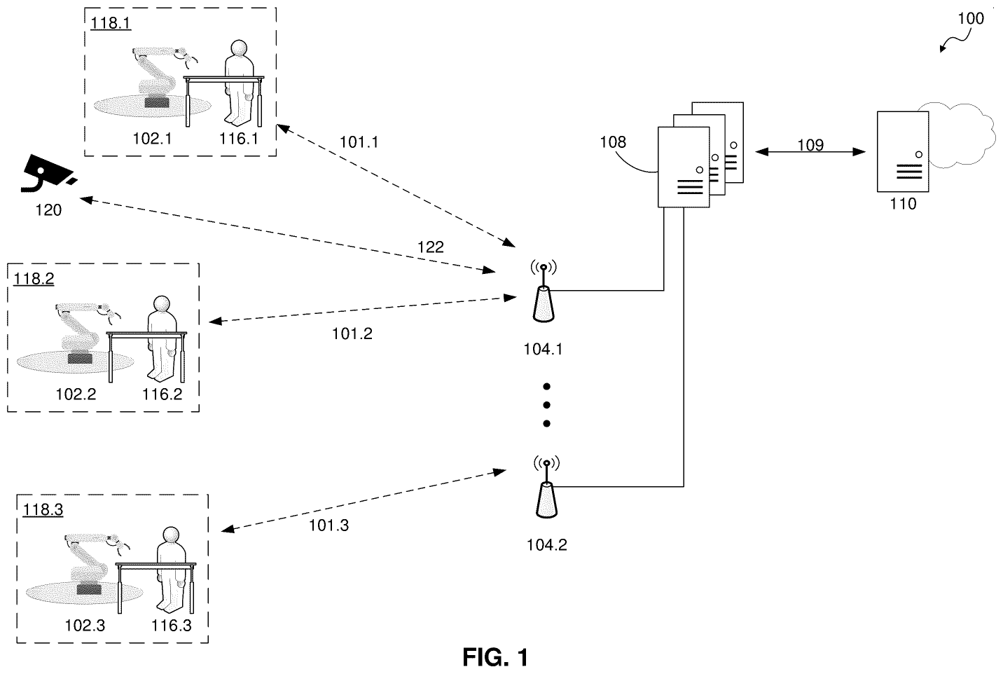

FIG. 1 illustrates a human-robot collaborative environment 100. The environment 100 may utilize cobots 102 (and/or other autonomous agents) in accordance with the disclosure. The environment 100 supports any suitable number of autonomous agents, with three cobots 102.1-102.3 being shown for case of explanation. Each of the cobots 102 are implemented in a collaborative workspace 118 that may include a working environment, such as a workbench, that is configured for human-robot collaboration with a human operator 116. Although the workspaces 118 are illustrated with a single respective cobot 102, one or more of the workspaces 118 may include two or more cobots 102.

The environment 100 may include one or more sensors 120 configured to monitor the locations and activities of the cobots 102, humans 116, machines, other robots, and/or other objects within the environment 100. Although not illustrated, the workspace 118 may include one or more sensors detected to the respective workspace 118. The sensor(s) 120 may include, for example, radar, LIDAR, optical sensors, infrared sensors, cameras, or other sensors as would be understood by one or ordinary skill in the art. The sensors 120 may communicate information (sensor data) with the computing device 108 (via access point(s) 104 along communication link 122). Although not shown in FIG. 1 for purposes of brevity, the sensor(s) 120 may additionally communicate with one another and/or with one or more of the cobots 102.

The cobots 102 may be a stationary robot having moveable components, such as one or moveable manipulator arms having an end-effector to complete localized tasks. The environment 100 supports any suitable number of cobots 102, with three cobots 102.1-102.3 being shown for ease of explanation. The environment 100 may be any suitable type of environment that may use autonomous agents (e.g., cobots 102), such as a factory, warehouse, hospital, office building, etc. The environment 100 may be a partial or fully autonomous environment. Although a centralized environment is illustrated in FIG. 1, with a centralized computing device 108, the environment may be partially or fully decentralized. Additionally, or alternatively, the workspaces 118 may include one or more local computing devices associated with the respective workspace 118 and configured to communicate with the cobot 102 and configured to control one or more operations of the cobot 102. The local computing device(s) may be communicatively coupled to the computing device 108 and/or one or more other local computing devices of one or more other workspaces 118.

The cobots 102 may have any suitable type of design and function to communicate with other components of a network infrastructure as further disused below (e.g., via access point(s) 104 along communication links 101). The cobots 102 may operate autonomously or semi-autonomously, and be configured as cobots that are configured to operate within the environment 100 (and within a workspace 118) to complete one or more specific tasks. One or more of the cobots 102 may alternatively be configured as a movable agent, such as an AMR or other movable robot.

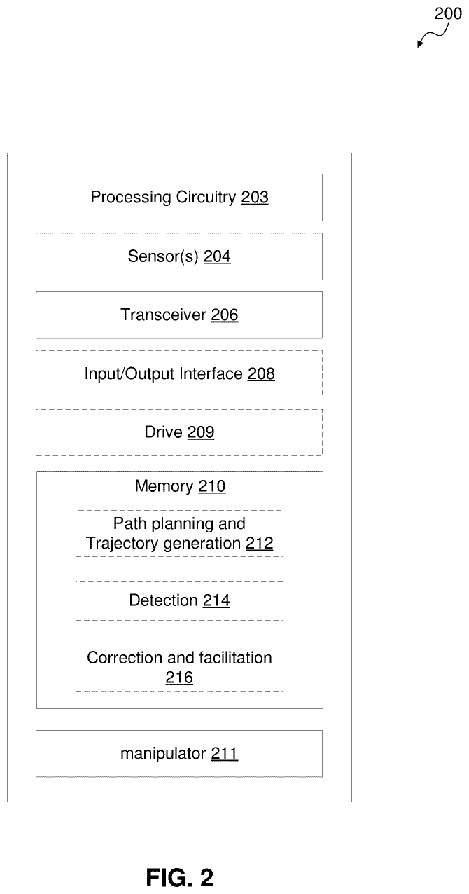

The cobots 102 may include any suitable number and/or type of sensors to determine characteristics of the cobots 102 and/or components(s) thereof, and/or enable sensing of their surroundings and the identification of feedback regarding the environment 100. As illustrated in FIG. 2, the cobots 102 may implement a suite of onboard sensors 204 to generate sensor data indicative of the location, position, velocity, heading orientation, etc. of the cobot 102 and/or one or more components (e.g., manipulator arm, arm joint(s), arm segment(s), and/or end effector) of the cobot 102. These sensors 204 may be implemented as any suitable number and/or type that are generally known and/or used for pose determinations (location, angle, position, etc.), autonomous navigation, and/or environmental monitoring. The sensor data may indicate the location, position, velocity, acceleration, heading orientation of the cobot 102 and/or one or more components (e.g., manipulator arm and/or arm segment(s), end effector) of the cobot 102, presence of and/or range to various objects near the cobot 102 and/or component(s) thereof. The cobot 102 may process this sensor data to identify characteristics (e.g., location, position, velocity, etc.) of the cobot 102 and/or component(s) thereof, characteristics of objects in the proximity of the cobot 102, obstacles or other relevant information within the environment 100, and/or other information as would be understood by one of ordinary skill in the art.

The cobots 102 may further be configured with any suitable number and/or type of wired communication components and/or wireless radio components (e.g., transceiver 206) to facilitate the transmission and/or reception of data. For example, the cobots 102 may transmit data indicative of current tasks being executed and/or characteristics (e.g., location, orientation, velocity, trajectory, heading, etc. of the cobot 102 and/or component(s) thereof). As another example, the cobots 102 may receive commands and/or information from the computing device 108. References to the computing device 108 may additionally or alternatively correspond to a local computing device within a particular workspace 118. Although not shown in FIG. 1 for purposes of brevity, the cobots 102 may additionally or alternatively communicate with one another to determine information with respect to the other cobots 102, as well as other information such as sensor data generated by other cobots 102.

The cobots 102 may operate within the environment 100 by communicating with the various components of the supporting network infrastructure. The network infrastructure may include any suitable number and/or type of components to support communications with the cobots 102. For example, the network infrastructure may include any suitable combination of wired and/or wireless networking components that operate in accordance with any suitable number and/or type of communication protocols. For instance, the network infrastructure may include interconnections using wired links such as Ethernet or optical links, as well as wireless links such as Wi-Fi (e.g., 802.11 protocols) and cellular links (e.g., 3GPP standard protocols, LTE, 5G, etc.). The network infrastructure may be, for example, an access network, an edge network, a mobile edge computing (MEC) network, etc. In the example shown in FIG. 1, the network infrastructure includes one or more cloud servers 110 that enable a connection to the Internet, which may be implemented as any suitable number and/or type of cloud computing devices. The network infrastructure may additionally include a computing device 108, which may be implemented as any suitable number and/or type of computing device such as a server. The computing device 108 may be implemented as an Edge server and/or Edge computing device, but is not limited thereto. The computing device 108 and/or server 110 may also be referred to as a controller or control device. The computing device 108 may be implemented as a respective local computing device within the workspace(s) 118. Further, as illustrated in FIG. 2, the cobot 102 may include processing circuitry 203 that is configured to provide internal computing and data processing for the cobot 102.

According to the disclosure, the computing device 108 may communicate with the one or more cloud servers 110 via one or more links 109, which may represent an aggregation of any suitable number and/or type of wired and/or wireless links as well as other network infrastructure components that are not shown in FIG. 1 for purposes of brevity. For instance, the link 109 may represent additional cellular network towers (e.g., one or more base stations, eNodeBs, relays, macrocells, femtocells, etc.). According to the disclosure, the network infrastructure may further include one or more access points (APs) 104. The APs 104 which may be implemented in accordance with any suitable number and/or type of AP configured to facilitate communications in accordance with any suitable type of communication protocols. The APs 104 may be configured to support communications in accordance with any suitable number and/or type of communication protocols, such as an Institute of Electrical and Electronics Engineers (IEEE) 802.11 Working Group Standards. Alternatively, the APs 104 may operate in accordance with other types of communication standards other than the 802.11 Working Group, such as cellular based standards (e.g., “private cellular networks) or other local wireless network systems, for instance. Additionally, or alternatively, the cobots 102 may communicate directly with the computing device 108 or other suitable components of the network infrastructure without the need to use the APs 104. Additionally, or alternatively, one or more of cobots 102 may communicate directly with one or more other cobots 102.

In the environment 100 as shown in FIG. 1, the computing device 108 is configured to communicate with one or more of the cobots 102 to receive data from the cobots 102 and to transmit data to the cobots 102. This functionality may be additionally or alternatively be performed by other network infrastructure components that are capable of communicating directly or indirectly with the cobots 102, such as the one or more cloud servers 110, for instance. However, the local nature of the computing device 108 may provide additional advantages in that the communication between the computing device 108 and the cobots 102 may occur with reduced network latency. Thus, according to the disclosure, the computing device 108 is used as the primary example when describing this functionality, although it is understood that this is by way of example and not limitation. The one or more cloud servers 110 may function as a redundant system for the computing device 108.

The computing device 108 may thus receive sensor data from each for the cobots 102 via the APs 104 (and/or using other wired and/or wireless technologies) and use the respective sensor data, together with other information about the environment 100 that is already known (e.g., data regarding the size and location of static objects in the environment 100, last known locations of dynamic objects, etc.), to generate an environment model that represents the environment 100. This environment model may be represented as a navigation grid having cells of any suitable size and/or shape, with each cell having specific properties with respect to the type of object contained (or not contained) in the cell, whether an object in the cell is static or moving, etc., which enables the environment model to accurately depict the nature of the environment 100. The environment model may thus be dynamically updated by the cobots 102 directly and/or via the computing device 108 on a cell-by-cell basis as new sensor data is received from the cobots 102 to generate a policy for the cobots 102. The updates to the shared environment model thus reflect any recent changes in the environment 100 such as the position and orientation of each of the cobots 102 and other obstacles that may change in a dynamic manner within the environment 100 (e.g., people, machinery, etc.). The shared environment model may additionally or alternatively be updated based upon data received from other sensors 120 or devices within the environment 100, such as stationary cameras for example, which may enable a more accurate depiction of the positions of the cobots 102 without relying on cobot communications. The workspaces 118 may additionally or alternatively include respective environment models that represent each of the respective workspaces 118.

Each cobot 102 may execute a planning algorithm (and/or use the environment model at a particular time) to calculate path plans and trajectories for the cobot 102 and/or components thereof. These path plans and trajectories may include sets of intermediate points (“waypoints”) or nodes that define a cobot trajectory between a starting point (starting pose) to a destination (goal pose) within the environment 100 and/or within a local environment (e.g., workspace 118) of the particular cobot 102. That is, the waypoints indicate to the cobots 102 how to execute a respective planned navigational path to proceed to each of the intermediate points at a specific time until a destination is reached. The path planning algorithm of one or more of the cobots 102 may be updated by the cobot 102 (e.g., processing circuitry 203) and/or computing device 108 e.g., processing circuitry 302). According to the disclosure, the computing device 108, server 110, and/or cobot(s) 102 may implement machine-learning (or use other artificial intelligence) to adapt one or more algorithms and/or models configured to control the operation of the cobots 102 within the environment 100.

The computing device 108 and/or cloud server(s) 110 may alternatively or additionally (potentially in collaboration with one or more of the cobots 102) calculate path plans and/or trajectories for one or more of the cobots 102. It should be appreciated that any combination of the cobots 102, computing device 108, and cloud server(s) 110 may calculate the navigational paths and/or trajectories. The cobots 102, computing device 108, and/or cloud server(s) 110 may include processing circuitry that is configured to perform the respective functions of the cobots 102, computing device 108, and/or cloud server(s) 110, respectively. One or more of these devices may further be implemented with machine-learning capabilities.

Information dynamically discovered by the cobots 102 may be, for instance, a result of each cobot 102 locally processing its respective sensor data. The sensor data may be used by the cobots 102 to determine which waypoint to add to a particular trajectory so that the assigned task(s) of the cobots 102 may be accomplished in the most efficient manner. The updated shared environment model may be maintained by computing device 108 (e.g., configured as a central controller) and shared with each of the cobots 102. The environment model may be stored in the computing device 108 and/or locally in a memory associated with or otherwise accessed by each one of the cobots 102. Additionally, or alternatively, the shared environment model may be stored in any other suitable components of the network infrastructure or devices connected thereto. The environment model represented as a navigation grid having cells of any suitable size and/or shape, with each cell having specific properties with respect to the type of object contained (or not contained) in the cell, whether an object in the cell is static or moving, etc., which enables the environment model to accurately depict the nature of the environment 100. Additionally, or alternatively, individual cobots 102 may manage a respective individualized environment model for the local environment (workspace 118) of the respective cobot 102.

### Agent (Cobot) Design and Configuration

Turning to FIG. 2, a block diagram of an autonomous agent 200 in accordance with the disclosure is illustrated. The autonomous agent 200 as shown and described with respect to FIG. 2 may be identified with one or more of the cobots 102 as shown in FIG. 1 and discussed herein. The autonomous agent 200 may include processing circuitry 202, one or more sensors 204, transceiver 206, memory 210, and manipulator 211. The manipulator 211 may be implemented as any suitable number and/or type of components configured to interact with and/or manipulate the environment and/or object(s) within the environment, such as a manipulator arm (e.g., with an end-effector) and/or other mechanism to interact with one or more objects. The manipulator 211 may include an end-effector, which may be situated at the distal end of the single- or multi-segmented manipulator arm.

The autonomous agent 200 may additionally include input/output (I/O) interface 208, and/or drive 209 (e.g., when the agent 200 is a mobile agent). The components shown in FIG. 2 are provided for case of explanation, and the autonomous agent 200 may implement additional, less, or alternative components as those shown in FIG. 2. I/O interface 208 may be implemented as any suitable number and/or type of components configured to communicate with the human(s) 116. The I/O interface 208 may include microphone(s), speaker(s), display(s), image projector(s), light(s), laser(s), and/or other interfaces as would be understood by one of ordinary skill in the arts. The drive 209 may be implemented as any suitable number and/or type of components configured to drive the autonomous agent 200, such as a motor or other driving mechanism. The processing circuitry 203 may be configured to control the drive 209 to move the autonomous agent 200 in a desired direction and at a desired velocity.

The cobot(s) 102 may implement a suite of onboard sensors 204 to generate sensor data indicative of the location, position, velocity, heading orientation, etc. of the cobot 102 and/or one or more components (e.g., manipulator arm and/or arm segment(s), end effector) of the cobot 102. These sensors 204 may be implemented as any suitable number and/or type that are generally known and/or used for autonomous navigation and environmental monitoring. Examples of such sensors may include radar, LIDAR, optical sensors, cameras, compasses, gyroscopes, positioning systems for localization, position sensors, angle sensors, accelerometers, etc. Thus, the sensor data may indicate the location, position, velocity, heading orientation of the cobot 102 and/or one or more components (e.g., manipulator arm and/or arm segment(s), joints, end-effector) of the cobot 102, presence of and/or range to various objects near the cobot 102 and/or component(s) thereof. The cobot 102 may process this sensor data to identify characteristics (e.g., location, position, velocity, etc.) of the cobot 102 and/or component(s) thereof, characteristics of objects in the proximity of the cobot 102, obstacles or other relevant information within the environment 100, and/or other information as would be understood by one of ordinary skill in the art. The cobot 102 may use onboard sensors 204 and/or environmental sensor(s) 120 to identify, for example, a position, orientation, velocity, direction, and/or location of its components to navigate its end effector to accomplish desired tasks.

The memory 210 stores data and/or instructions such that, when the instructions are executed by the processing circuitry 202, cause the cobot 200 to perform various functions as described herein. The memory 210 may be implemented as any well-known volatile and/or non-volatile memory. The memory 210 may be implemented as a non-transitory computer readable medium storing one or more executable instructions such as, for example, logic, algorithms, code, etc. The instructions, logic, code, etc., stored in the memory 210 are may be represented by various modules which may enable the features described herein to be functionally realized. For example, the memory 210 may include one or more modules representing an algorithm, such as a path planning and trajectory generating module 212 configured to perform one or more path planning and trajectory generating algorithms to execute the movements of the cobot 200, including the movement of components (e.g., end-effector) of the cobot(s) 200; a detection module 214 configured to perform one or more detection algorithms to detect one or more errors and/or anomalies of a performed task, subtask, and/or atomic action, and/or associated with an end state of the workspace 118, and/or a correction and facilitation module 216 configured to perform one or more correction and facilitation algorithms to perform one or more corrections and/or facilitation operations (e.g. operating in a correction mode and/or facilitation mode). For hardware implementations, the modules associated with the memory 210 may include instructions and/or code to facilitate control and/or monitor the operation of such hardware components. Thus, the disclosure includes the processing circuitry 202 executing the instructions stored in the memory in conjunction with one or more hardware components to perform the various functions described herein.

The processing circuitry 202 may be configured as any suitable number and/or type of computer processors, which may function to control the autonomous agent 200 and/or other components of the autonomous agent 200. The processing circuitry 202 may be identified with one or more processors (or suitable portions thereof) implemented by the autonomous agent 200. The processing circuitry 202 may be configured to carry out instructions to perform arithmetical, logical, and/or input/output (I/O) operations, and/or to control the operation of one or more components of autonomous agent 200 to perform various functions associated with the disclosure as described herein. For example, the processing circuitry 202 may include one or more microprocessor cores, memory registers, buffers, clocks, etc., and may generate electronic control signals associated with the components of the autonomous agent 200 to control and/or modify the operation of these components. For example, the processing circuitry 202 may control functions associated with the sensors 204, the transceiver 206, interface 208, drive 209, memory 210, and/or manipulator 211. The processing circuitry 202 may additionally perform various operations to control the movement, speed, and/or tasks executed by the autonomous agent 200, which may be based upon path planning and/or trajectory algorithms executed by the processing circuitry 202.

The processing circuitry 202 may execute: the one or more path planning and trajectory generating algorithms 212 to execute the movements of the cobot 102, including the movement of components (e.g., end-effector) of the cobot(s) 102; one or more detection algorithms 214 to detect one or more errors and/or anomalies of a performed task, subtask, and/or atomic action, and/or associated with an end state of the workspace 118; one or more correction and facilitation algorithms 216 to perform one or more corrections and/or facilitation operations (e.g. operating in a correction mode and/or facilitation mode); and/or the one or more other algorithms to perform one or more other function(s) and/or operation(s) of the cobot 102. The path planning, trajectory generation, error and/or anomaly detection, correction operations, facilitation operations, and/or other operations may be iteratively performed. The cobots 102 may also use any suitable number and/or type of hardware and software configurations to facilitate one or more functions of the cobot and/or its component(s). For example, each cobot 102 may implement a controller or control device that may comprise one or more processors or processing circuitry 202, which may execute software that is installed on a local memory 210 to perform various path planning, trajectory calculations, navigational-related functions (e.g., pose estimation, SLAM, octomap generation, etc.), detection functions, correction functions, and/or facilitation functions.

The transceiver 206 may be implemented as any suitable number and/or type of components configured to transmit and/or receive data packets and/or wireless signals in accordance with any suitable number and/or type of communication protocols. The transceiver 206 may include any suitable type of components to facilitate this functionality, including components associated with known transceiver, transmitter, and/or receiver operation, configurations, and implementations. Although depicted in FIG. 2 as a transceiver, the transceiver 206 may include any suitable number of transmitters, receivers, or combinations of these that may be integrated into a single transceiver or as multiple transceivers or transceiver modules. For example, the transceiver 206 may include components typically identified with an RF front end and include, for example, antennas, ports, power amplifiers (PAS), RF filters, mixers, local oscillators (LOs), low noise amplifiers (LNAs), upconverters, downconverters, channel tuners, etc. The transceiver 206 may also include analog-to-digital converters (ADCs), digital to analog converters, intermediate frequency (IF) amplifiers and/or filters, modulators, demodulators, baseband processors, and/or other communication circuitry as would be understood by one of ordinary skill in the art. The transceiver 206 may additionally or alternatively be configured for wired communications and include any suitable number and/or type of wired communication components to facilitate the transmission and/or reception of data using one or more wired technologies. For example, the cobot 200 may be connected via a wired connection to a controller disposed within the workspace 118 and/or to one or more other cobots.

Although the disclosure includes examples of the environment 100 being a factory or warehouse with one or more collaborative workspaces 118 that support one or more cobots 102 operating within the respective workspaces 118, this is by way of example and not a limitation. The teachings of the disclosure may be implemented in accordance with any suitable type of environment and/or type of autonomous agent. For instance, the environment 100 may be outdoors and be identified with a region such as a roadway that is utilized by autonomous vehicles. Thus, the teachings of the disclosure are applicable to cobots as well as other types of autonomous agents that may operate in any suitable type of environment based upon any suitable application or desired function.

The cobots 102 may operate within the environment 100 independently and/or cooperatively by communicating with one or more other cobots 102 and/or computing device (e.g., controller) 108. The cobots 102 may include any suitable combination of wireless communication components that operate in accordance with any suitable number and/or type of wireless communication protocols. For instance, the network infrastructure may include optical links and/or wireless links such as Wi-Fi (e.g., Institute of Electrical and Electronics Engineers (IEEE) 802.11 Working Group Standards) and cellular links (e.g., 3GPP standard protocols, LTE, 5G, etc.). Communications between cobots 102 may be directed to one or more individual cobots 102 and/or broadcast to multiple cobots 102. Communications may be relayed by or more network components (e.g., access points) and/or via one or more other intermediate cobots 102.

The cobots 102 may be configured to process sensor data from one or more of its sensors and/or other information about the environment 100 that is already known, such as map data, which may include data regarding the size and location of static objects in the environment 100, last known locations of dynamic objects, etc. The processed data may be used to determine one or more trajectories.

According to the disclosure, the cobot(s) 102 may implement machine-learning to adapt one or more algorithms and/or models configured to control the operation of the cobot 102 within the environment 100. The cobots 102 may include processing circuitry that is configured to perform the respective functions of the cobot 102.

Information dynamically discovered by the cobots 102 may be, for instance, a result of each cobot 102 locally processing its respective sensor data. Because of the dynamic nature of the environment 100, each cobot 102 may calculate its own respective path plans and/or trajectories in a continuous and iterative manner based on its sensor data, senor or other data from one or more other cobots 102, map or other data as would be understood by one of ordinary skill in the arts.

### Computing Device (Controller) Design and Configuration

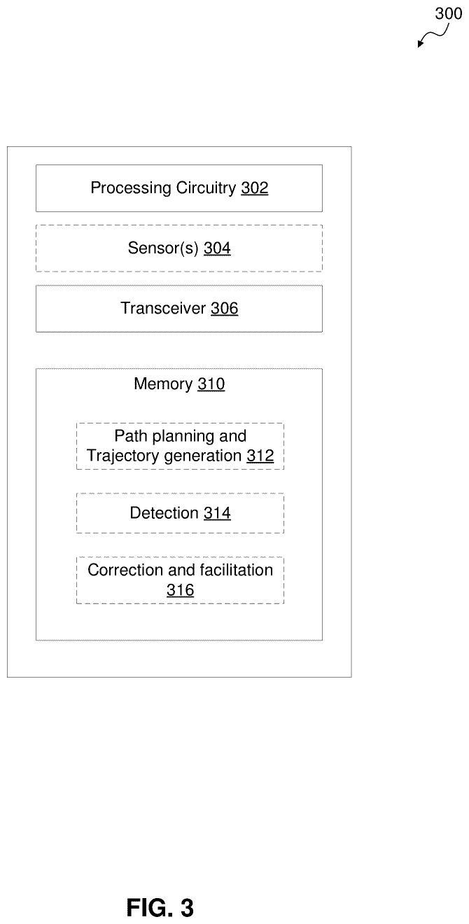

FIG. 3 illustrates a block diagram of a computing device 300, in accordance with the disclosure. The computing device (controller) 300 as shown and described with respect to FIG. 3 may be identified with the computing device 108 and/or server 110 as shown in FIG. 1 and discussed herein, and/or as a local computing device within the workspace 118 and connected to the respective cobot(s) 102 within the workspace 118, for instance. The computing device 300 may be implemented as an Edge server and/or Edge computing device, such as when identified with the computing device 108 implemented as an Edge computing device and/or as a cloud-based computing device when identified with the server 110 implemented as a cloud server.

The computing device 300 may include processing circuitry 302, one or more sensors 304, a transceiver 306, and a memory 310. In some examples, the computer device 300 is configured to interact with one or more external sensors (e.g., sensor 120) as an alternative or in addition to including internal sensors 304. The components shown in FIG. 3 are provided for ease of explanation, and the computing device 300 may implement additional, less, or alternative components as those shown in FIG. 3.

The processing circuitry 302 may be configured as any suitable number and/or type of computer processors, which may function to control the computing device 300 and/or other components of the computing device 300. The processing circuitry 302 may be identified with one or more processors (or suitable portions thereof) implemented by the computing device 300.

The processing circuitry 302 may be configured to carry out instructions to perform arithmetical, logical, and/or input/output (I/O) operations, and/or to control the operation of one or more components of computing device 300 to perform various functions as described herein. For example, the processing circuitry 302 may include one or more microprocessor cores, memory registers, buffers, clocks, etc., and may generate electronic control signals associated with the components of the computing device 300 to control and/or modify the operation of these components. For example, the processing circuitry 302 may control functions associated with the sensors 304, the transceiver 306, and/or the memory 310.

According to the disclosure, the processing circuitry 302 may be configured to: perform path planning and/or trajectory generation (possibly in collaboration with the cobot(s) 102) for one or more cobots 102; control (possibly in collaboration with the cobot(s) 102) the operation of the cobot(s) 102 within the environment 100, such as controlling movement of the cobot(s) 102 and/or its components within the environment 100; control the cobot(s) 102 to gather additional data or information about the environment 100; perform (and/or control the cobot(s) 102 to perform) anomaly and/or error detection based on data (e.g., sensor data) and/or other information from the cobot(s) 102; perform (and/or control the cobot(s) 102 to perform) one or more correction and/or facilitation operations; and/or one or more other functions as would be understood by one of ordinary skill in the art.

The sensors 304 may be implemented as any suitable number and/or type of sensors that may be used for navigation and/or environmental monitoring. Examples of such sensors may include radar, LIDAR, optical sensors, cameras, compasses, gyroscopes, positioning systems for localization, accelerometers, etc. In some examples, the computing device 300 is additionally or alternatively configured to communicate with one or more external sensors similar to sensors 304 (e.g., sensor 120 in FIG. 1).

The transceiver 306 may be implemented as any suitable number and/or type of components configured to transmit and/or receive data packets and/or wireless signals in accordance with any suitable number and/or type of communication protocols. The transceiver 306 may include any suitable type of components to facilitate this functionality, including components associated with known transceiver, transmitter, and/or receiver operation, configurations, and implementations. Although depicted in FIG. 3 as a transceiver, the transceiver 306 may include any suitable number of transmitters, receivers, or combinations of these that may be integrated into a single transceiver or as multiple transceivers or transceiver modules. For example, the transceiver 306 may include components typically identified with an RF front end and include, for example, antennas, ports, power amplifiers (PAs), RF filters, mixers, local oscillators (LOs), low noise amplifiers (LNAs), upconverters, downconverters, channel tuners, etc. The transceiver 306 may also include analog-to-digital converters (ADCs), digital to analog converters, intermediate frequency (IF) amplifiers and/or filters, modulators, demodulators, baseband processors, and/or other communication circuitry as would be understood by one of ordinary skill in the art.

The memory 310 stores data and/or instructions such that, when the instructions are executed by the processing circuitry 302, cause the computing device 300 to perform various functions as described herein. The memory 310 may be implemented as any well-known volatile and/or non-volatile memory. The memory 310 may be implemented as a non-transitory computer readable medium storing one or more executable instructions such as, for example, logic, algorithms, code, etc. The instructions, logic, code, etc., stored in the memory 310 are may be represented by various modules which may enable the features described herein to be functionally realized. For example, the memory 310 may include one or more modules representing an algorithm, such as a path planning and trajectory generating module 312 configured to perform one or more path planning and trajectory generating algorithms to execute the movements of the cobot 102, including the movement of components (e.g., end-effector) of the cobot(s) 102; a detection module 314 configured to perform one or more detection algorithms to detect one or more errors and/or anomalies of a performed task, subtask, and/or atomic action, and/or associated with an end state of the workspace 118, and/or a correction and facilitation module 316 configured to perform one or more correction and facilitation algorithms to perform one or more corrections and/or facilitation operations (e.g. operating in a correction mode and/or facilitation mode). For hardware implementations, the modules associated with the memory 310 may include instructions and/or code to facilitate control and/or monitor the operation of such hardware components. Thus, the disclosure includes the processing circuitry 302 executing the instructions stored in the memory in conjunction with one or more hardware components to perform the various functions described herein.

The processing circuitry 302 may execute: the one or more path planning and trajectory generating algorithms 312 to execute the movements of the cobot 102, including the movement of components (e.g., end-effector) of the cobot(s) 102; one or more detection algorithms 314 to detect one or more errors and/or anomalies of a performed task, subtask, and/or atomic action, and/or associated with an end state of the workspace 118; one or more correction and facilitation algorithms 316 to perform one or more corrections and/or facilitation operations (e.g. operating in a correction mode and/or facilitation mode); and/or the one or more other algorithms to perform one or more other function(s) and/or operation(s) of the cobot 102.

### Detection and Correction Process

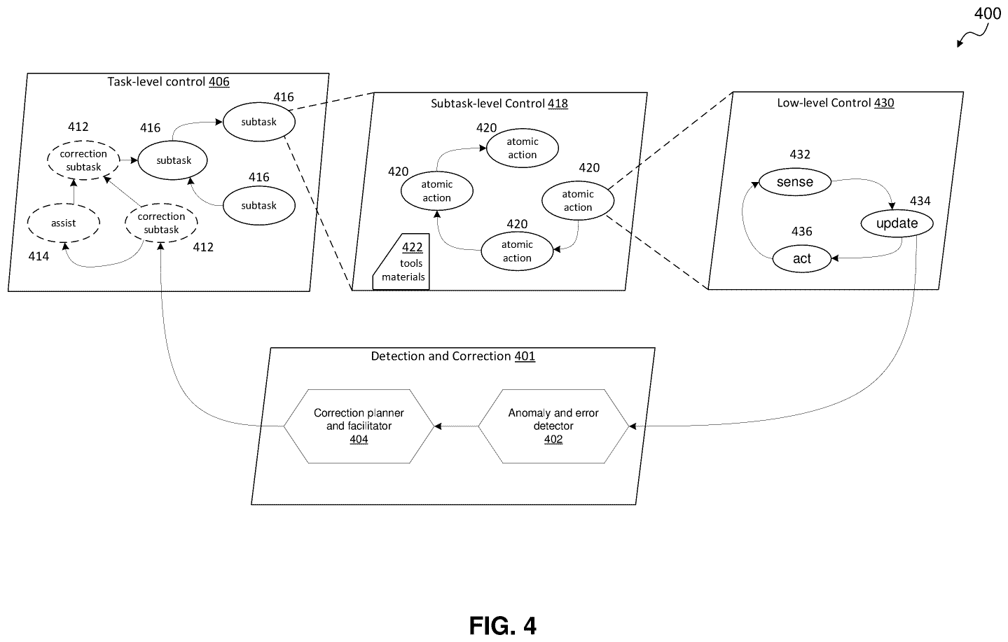

FIG. 4 illustrates a flowchart of a detection and correction process 400 for a task control flow in accordance with the disclosure. The process 400 shown may be performed by one or more cobots 102, the computing device 108, the server 110, or any combination thereof. References to the “system” performing one or more operations may include any combination of the cobot(s) 102, the computing device 108, and/or the server 110 performing the particular operation(s). The process may be iteratively performed until the task is met or each identified sub-task and/or atomic action is completed. Two or more of the various operations illustrated in FIG. 4 may be performed simultaneously in some configurations.

Task-level control 406 may include one or more subtasks 416 to be performed by the cobot 102 and/or human operator 116. In the task-level control, a task is decomposed into one or more subtasks 416. For example, a sequence of several subtasks is illustrated, where the subtask(s) 416 may include one or more atomic actions 420 as illustrated in the subtask-level control 418. That is, the subtasks 416 may be further decomposed into one or more atomic actions 420. Each of the subtask(s) may be completed by a single agent (e.g., cobot 102 or human operator 116), while atomic actions 420 may include instructions to attain a partial goal of a subtask. For example, the “Place screw in Hole #1” subtask may be composed of the following atomic actions: pick object [screw], transport to [hole #1], peg-in-hole. Atomic actions 420 may be described in natural language for human operators 116 and as software control algorithms for cobots 102.

The subtask-level control 418 may include information 422 identifying one or more tool(s) and/or materials that are used (e.g., by the human and/or cobot) to complete the subtask 416 and/or one or more atomic actions 420 therein. The atomic action(s) 420 may represent low-level controls 430, which may include the sequence of sensing 432 (e.g., using one or more sensors), updating 434 the current state and/or control instructions based on the sensed data, and controlling or instructing the cobot and/or human to act.

The process 400 may include detection and correction operations 401, which may include the detection of one or more anomalies and/or errors at operation 402, and the correction and/or facilitation of a correction operation 404 of the one or more anomalies and/or errors. The detection and correction operations 401 may represent a human-error reduction system. In this example, the operations 402 and 404 may be represented by various modules which may enable the features described herein to be functionally realized by executing one or more instructions, logic, code, etc., configured to perform the detection, correction and/or facilitation. The human-error reduction system, which may be referred to as the detection and correction system 401, may be implemented in the cobot 102, and/or in the computing device 108 and/or server 110. For example, the processing circuitry 203 may be configured to execute the detection algorithm 214 and the correction and facilitation algorithm 216 to perform the operations of the detector 402 and the correction planner and facilitator 404, respectively.

According to the disclosure, the cobot 102 may be configured to perform a continuous sense-update-act loop 430 (e.g., closed-loop control) while executing a task. The sense-update-act loop 430 captures information about the state of the environment (e.g. workspace 118) and tracks the state of the task (at the sense operation 432), updates the internal representation (update 434), and determines the next action (act 436) towards its completion.

The task description may include high level information on how to execute the task and guides the cobot 102 to plan the next steps based on the currently tracked task state. The task state may be continuously updated (update 434) with information from the state (sense 432) of the environment (e.g., scene state estimation) and the human execution (e.g., operator state estimation). The anomaly and error detector 402 may detect anomalies in the execution of the task(s) based on changes to the workspace environment, where anomalies may correspond to or lead to one or more errors that are detectable by the detector 402. According to the disclosure, the detection and correction system 401 may check for anomalies with every update in the loop.

The anomaly and error detector 402 may be configured to analyze the updated workspace environment to detect one or more anomalies, and perform error analysis and detection based on the detected anomalies. The correction planner and facilitator 404 may determine whether the error(s) may be addressed and corrected by the correction planner and facilitator 404, or if human intervention is necessary. The correction planner and facilitator 404 may temporarily modify the task description by generating a correction subtask 412, which is configured to correct the error if correction is deemed possible. If the cobot 102 is unable to correct the error, the cobot 102 may facilitate the correction of the error by assisting the human operation 116 in addressing the error by generating an assist operation 414 that provides operations performed by the cobot 102 to assist in the error correction by the human operation 116. The task description and the process to correct errors is described in more detail below.

With the information produced by the error detector 402, the correction planner and facilitator 404 may generate a notification and/or warning to notify the human operator 116 about the detected error, notify about a recovery plan (if recoverable), and/or to request that the human operator 116 address the error and whether the cobot 102 may assist the human operator 116 in correcting the error. The cobot 102 may be configured to begin execution of an error correction in response to performance of the current subtask is completed (e.g., as soon as the current subtask is finished). When there is a path to correction, the correction planner and facilitator 404 may determine whether the cobot 102 may prepare and/or provide components and/or materials, prepare and/or provide tools, and/or other assistance operations. Alternatively, or additionally, the correction planner and facilitator 404 may be configured to assist the human operator 116 in performing a subtask absent an error being detected to help the human operator 116 complete the subtask(s) (e.g., more quickly, accurately, and/or efficiently).

### Task Description

Each task may include one or more subtasks that may be completed in collaboration with the human operator 116. The task description identifying the particular task may include one or more subtask actions defining the particular subtasks that are required to perform the task. The subtask action representing a corresponding subtask may include information defining the particular subtask. Therefore, a task including multiple subtasks may have a task description that includes corresponding set of subtask actions that collectively define the actions to be performed to accomplish the task.

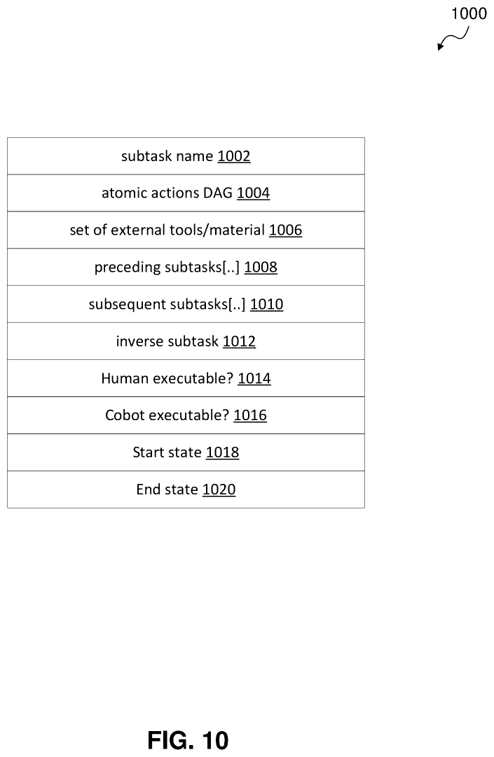

The subtask action may include one or more fields including information, requirement(s), and/or other criteria for the particular subtask. The subtask action 1000 may be formatted as shown in FIG. 10, for example. According to the disclosure, the subtask action 1000 may include a subtask name 1002 describing the action performed by the corresponding subtask; an atomic action Directed Acyclic Graph (DAG) 1004 that represents the atomic actions in a graphical form using corresponding nodes for each of the atomic actions of the subtasks, where each directed edge from a previous atomic action to a subsequent atomic action represents a constraint and/or precedence in the order of execution of the atomic actions; tool/material information 1006 identifying one or more tools and/or materials that are to be used to perform the particular subtask and/or one or more atomic actions therein; one or more preceding subtasks 1008 that are performed before the particular subtask corresponding to the respective subtask action 1000; one or more subsequent subtasks 1010 that are to be performed following the particular subtask corresponding to the respective subtask action 1000; an inverse subtask 1012 defining one or more atomic actions that when performed, reverse the particular subtask corresponding to the respective subtask action 1000 and/or one or more preceding subtasks; a human-executable identifier 1014 that identifies if the human operator 116 may perform the particular subtask corresponding to the respective subtask action 1000; a cobot-executable identifier 1016 that identifies if the cobot 102 may perform the particular subtask corresponding to the respective subtask action 1000; a start state 1018 defining an expected state of the workspace 118 for the particular subtask corresponding to the respective subtask action 1000 to be performed; and an end state 1020 defining an expected state of the workspace 118 following the successful performance of the particular subtask corresponding to the respective subtask action 1000 to be performed.

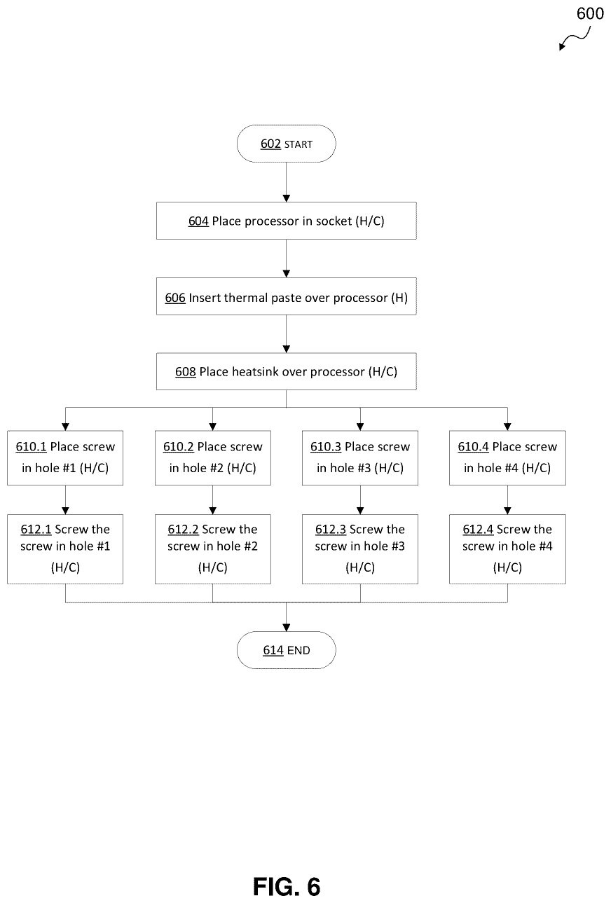

According to the disclosure, the task description may be represented in graphical form using a DAG representation as illustrated in FIG. 6. The task description 600 includes various rectangular nodes represents a subtask to be executed for the particular task. Each directed edge from a previous subtask to a subsequent subtask represents a constraint and/or precedence in the order of execution of the subtasks. For example, the directed edge from subtask 604 to subtask 606 illustrates that subtask 604 must be performed and completed before subtask 606 is to be performed. As further illustrated by the parallel arrangement, two or more subtasks may be performed in any order as represented by subtasks 610.1 to 610.4, and similarly subtasks 612.1 to 612.4, as long as the preceding subtask in the precedence order has been completed. That is, the placement of screws may be performed in any order. Once a screw has been placed for a particular screw (e.g., for hole #1 at operation 610.1), the subsequence subtask (e.g., screw the screw in hole #1 at operation 612.1) for that corresponding preceding subtask may be performed. In an alternative configuration, the precedence order may require that all subtasks in a parallel arrangement must be completed before any of the subsequence subtasks may be performed. Subtask within a parallel arrangement may also be performed simultaneously. For example, the human operator 116 (or cobot 102 with two end-effectors) may place a screw with each hand (end-effector), or the human operator 116 may place one screw while the cobot 102 places another if both the human operator 116 and cobot 102 are capable of performing the subtask (e.g., as identified in the human-executable identifier 1014 and cobot-executable identifier 1016).

The task description 600 shown in FIG. 6 describes how to assemble a processor to a motherboard. The task starts at subtask 602, which starts the performance of the task, and precedes to subtask 604 which corresponds to the placement of the processer in the socket. As shown, each of the subtasks includes an executable identifier that may include a human-executable identifier and cobot-executable identifier. For example, the subtask 604 includes both a human-executable identifier (H) and cobot-executable identifier (C), which represents that the subtask 604 may be performed by either the human operator 116 or the cobot 102. Following the performance and completion of subtask 604, the task 600 proceeds to subtask 606, where thermal paste is inserted over the processer, which must be performed by the human operator 116 as reflected by the human-executable identifier (H). The task description 600 then precedes to subtask 608, where the heatsink is placed over the processor (e.g., by either the human or cobot as reflected by “H/C”). After completion of subtask 608, the task description 600 then precedes to subtasks 610.1 to 610.4, where screws are placed in respective holes #1-4. As reflected by the “H/C” and the parallel arrangement, each of these subtasks may be performed by either the human operator 116 or the cobot 102, may be performed in any order, and two or more subtasks may be performed simultaneously. Upon completion of the respective subtask 610.1 to 610.4, the subsequent respective subtask 612.1 to 612.4 may be performed, where the respective screws are screwed in. Alternatively, subtasks 612.1 to 612.4 may be performed only after all of subtasks 610.1 to 610.4 are completed. After all of subtasks 612.1 to 612.4 are completed, the task description 600 proceeds to subtask 614 where the task ends.

According to the disclosure, for subtasks or atomic actions that have dual executable identifiers—“H/C” reflecting that the subtask/atomic action may be performed by either the human operator 116 or the cobot—the system may be configured so that either the cobot 102 will attempt to perform the operations by default so that the system operates in an autonomous mode, or that the human will perform the action by default. If the cobot 102 is selected as the primary, default performer, the cobot 102 may be configured to detect (e.g., using one or more sensors) if the human operator 116 is attempting to perform the operation or appears to likely begin performing. The cobot 102 may be configured to monitor the workspace 118 and perform the operation if the human operator 116 is not attempting to perform the operation. The cobot 102 may wait for a predetermined period of time (e.g., a timeout period) to allow the human operator 116 to perform the operation if desired by the human operator 116. Additionally, or alternatively, the decision on which actor—the cobot 102 or the human operator 116—is to perform the operation may be based on one or more criterion, such as proximity to the area in the workspace 118 where the subtask/atomic action is to be performed, the energy consumption of the cobot to perform the particular subtask/atomic action, the difficulty level of performing the particular subtask/atomic action; the required accuracy and/or precision of the particular subtask/atomic action; the danger level associated with the particular subtask/atomic action; and/or other criteria. According to the disclosure this or similar criterion may be used to determine which actor performs subtasks/atomic actions in parallel and/or simultaneously configurations. For example, the cobot 102 may perform subtask 610.1 while the human operator 116 performs subtask 610.2 because the cobot's end-effector is closer to hole #1.

### Error Correction Algorithm

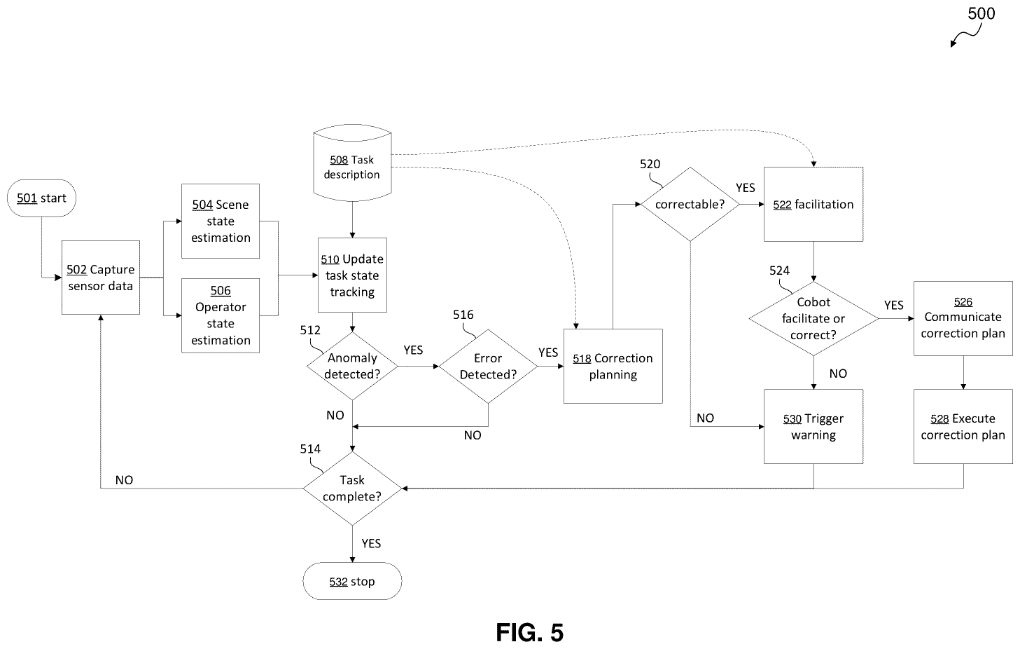

Turning to FIG. 5, a flowchart 500 of an error correction process according to the disclosure is shown. The process 500 shown may be performed by the cobot 102, the computing device 108, server 110, or any combination thereof. References to the “system” performing one or more operations may include any combination of the cobot(s) 102, the computing device 108, and/or the server 110 performing the particular operation(s). The process may be iteratively performed until the goal (e.g., task completion) is met or each identified sub-goal (e.g., subtask, atomic action) is completed. Two or more of the various operations illustrated in FIG. 5 may be performed simultaneously in some configurations. Further, the order of the various operations is not limiting and the operations may be performed in a different order in some configurations. Discussion of the operations may additionally, or alternatively include reference to the structural component(s) performing the operation(s). For example, in discussing the correction planning operation 518, reference may be made to the “correction planner 518” embodied by the processing circuitry 203, correction planner and facilitator 404, and/or correction planning and facilitation module 216 in memory 210. Similarly, in discussion the anomaly detection operation 512 and/or error detection operation 516, reference may be made to the “anomaly detector 512” and/or “error detector 516” embodied by the processing circuitry 203, anomaly and error detector 402, and/or detection module 214 in memory 210.

The flowchart 500 begins at operation 501 and transitions to operation 502, where sensor data is captured. For example, the sensor data may be captured by the cobot's onboard sensors 204 and/or environmental or workspace sensor 120.

After operation 502, the flowchart 500 transitions to operations 504 and 506. Operations 504 and 506 may be performed simultaneously, partially simultaneously, or sequentially. At operation 504, the scene state of the environment (e.g., of workspace 118) is estimated or otherwise determined based on the sensor data captured at operation 502. For example, the current state of the workspace 118 may be determined, including the current positions and movement of objects within the workspace 118. At operation 506, the operator state of the cobot 102 (and/or one or more of its components) and/or of the human operator 116 is estimated or otherwise determined based on the sensor data captured at operation 502. For example, the current state of the cobot 102, the human operator 116, and/or other cobots and/or humans within the workspace 118 may be determined, including the current positions and movement of the cobot 102, the human operator 116, and/or other cobots and/or humans.

At operation 510, the task state tracking is updated. For example, the current progress of the task, such as which subtask and/or atomic actions have been completed for the task. The task state tracking may be updated based on the task description 508 and/or the determined scene state estimation and/or operator state estimation. The task description 508 may be represented by a DAG (e.g., FIG. 6) and/or task action (FIG. 10).

According to the disclosure, the state of the task may be continuously monitored by the system to assert the execution state and detect anomalies to be analyzed for error detection. The workspace 118 may be a shared workbench, which are semi-structured spaces that may include one or more sensors to aid in the task of state tracking (operation 510). Semi-structured spaces refer to a partially controlled space (e.g., half of a completely controlled space, such as a production chain line) where each piece is precisely positioned. Open-world, unstructured spaces (e.g. household kitchen) is a space where almost any object can appear into the scene and there are no predefined locations for items.

In semi-structured spaces, the tools, surfaces, and other components that can be present in the workspace are limited and known. Moreover, those can be instrumented (e.g., RFID, barcodes, IMU) to retrieve the state of each component present in the scene. Such spaces may also include one or more computer vision solutions to detect the state of human operators 116. Additionally, or alternatively, semi-structured spaces may implement specialized gloves or eyewear worn by the human operation 116 to aid their tracking. According to the disclosure, properties of semi-structured spaces may be leveraged to work directly in the symbolic space while the system may be agnostic to environmental sensorization/calibration and the technology used to retrieve the state of the environment, objects and human operators.

At operation 512, analysis may be performed on the updated task state tracking to determine if one or more anomalies are present. For example, an expected state of the workspace for the particular milestone in the task state tracking may be compared to the current state of the workspace for the same milestone. If there is a divergence in the compared states, it may be determined that an anomaly is present (YES at operation 512). It will be appreciated that not all anomalies are considered, or result in, an error. For example, unlike robots, humans and interacting objects are not repeatable and easily predictable. The humans 116 may interact with the environment in different ways or may use different strategies to solve the same task. Soft bodies, liquids and contact rich interactions are also difficult to accurately predict. These sources of low repeatability can create anomalies in the evolution of each atomic action or at higher levels.

If an anomaly is not detected (NO at operation 512), the flowchart 500 transitions to operation 514, where it is determined if the task is complete. That is, the system may check is all subtasks of the task have been completed. If not (e.g., one or more subtasks remain), the flowchart 500 returns to operation 502, where additional sensor data is captured and the process may be repeated for the remaining subtask(s). In this configuration, the operations 502, 504, 506, 510, 512, and 514 form a sense-update-act loop, where the loop me be iteratively performed until the task is complete. If there are no remaining subtasks, the flowchart 500 transitions to operation 532, where the flowchart 500 ends.

If an anomaly is detected (YES at operation 512), the flowchart 500 transitions to operation 516, where one or more error detection operations are performed, the detected anomaly is analyzed to determine if an error has occurred. Advantageously, the system is configured to detect human errors, which may be in addition to detecting errors caused by the cobot(s) 102. According to the disclosure, the error detection may be based on the current and expected end states of the current subtask. For example, the error-detection analysis may include a comparison of the current end state for the current subtask (e.g., as determined based on the sensor data and/or state estimations) with the expected end state (e.g. end state 1020 reflected in the task description) for the current subtask. If the determined end state for current subtask does not match the expected end state (e.g., end state 1020) for the subtask, it can be determined that one or more errors have occurred. Additionally, or alternatively, an error may be detected if it is detected that one or more atomic actions and/or subtasks have not been performed, or have been performed incorrectly.

Within the environment, many different types of errors are possible. According to the disclosure, the system may be configured to detect errors caused by the human operator 116, which advantageously increases the scope of error detection beyond conventional solutions limited to only errors caused by the robot. According to the disclosure, the detectable errors may include an “incomplete subtask error,” an “incorrect subtask error,” a “skipped subtask error,” and/or other error types.

An “incomplete subtask error” may include an error resulting from a subtask that fails to complete. A subtask may be considered incomplete when the current state corresponds to a transition state between the expected start state and the expected end state for the subtask. For example, a screw that was partially screwed, may result in error detector 516 returning a result of an “incomplete subtask error.” As described in more detail below with reference to the correction planner 518, incomplete subtask errors may be addressed by reversing one or more operations of the subtask (e.g., using the information within the inverse subtask 1012 in the subtask action 1000) and repeating the performance of the subtask. Alternatively, the correction may include identifying the transition state at which the error occurred, and completing the subtask from the transition state to the expected end state by performing the remaining atomic action(s) of the subtask.

An “incorrect subtask error” may include an error resulting from an incorrectly executed subtask, which may include one or more incorrectly performed atomic actions and/or one or more omitted atomic actions of the subtask. These subtasks are typically incorrectly executed. For example, with reference to the example task illustrated in FIG. 6, an incorrect subtask error may include the case where the wrong types of screws are used, the heatsink being placed in the wrong orientation, etc.

A “skipped subtask error” may include an error resulting from the human operator 116 omits (e.g., forgets, skips, or otherwise fails to perform) one or more subtasks that precede the subtask being currently executed. For example, with reference to the example task illustrated in FIG. 6, a skipped subtask error may include the case where the heatsink is installed (subtask 608) before installing the processor (subtask 604) and/or before the thermal paste is installed (subtask 606).

In addition to classifying the errors based on error type, the errors may be categorized as a recoverable error or an unrecoverable error. The recoverability may be determined with respect to the cobot. That is, whether the cobot 102 is capable of recovering from the error by taking corrective measures to fully address the error. The recoverability may depend on the specific implementation of the cobot system and the defined task. For example, some errors may be recoverable based on the particular attributes and capabilities of the cobot. If the hardware capabilities of the robot do not allow it to pick up, for example, a screwdriver, then removing a dropped screwdriver from the workbench of the workspace will be defined as an unrecoverable error. Further, even if the cobot may be capable of picking the screwdriver up, the error may still be categorized as “unrecoverable” if picking up the object would potentially cause additional damage or errors (e.g., when the screwdriver is laying on a motherboard, picking it up may damage the motherboard components).

If no error is detected (NO at operation 516), the flowchart 500 transitions to operation 514, where it is determined if the task is complete. That is, the system may check is all subtasks of the task have been completed. If not (e.g., one or more subtasks remain), the flowchart 500 returns to operation 502, where additional sensor data is captured and the process may be repeated for the remaining subtask(s). If there are no remaining subtasks, the flowchart 500 transitions to operation 532, where the flowchart 500 ends.

If an error is detected (YES at operation 516), the flowchart 500 transitions to operation 518, where one or more correction planning operations are performed to determine if the error is correctable. The correction planning may be based on the task description 508 and/or the result of the error detection (e.g., error classification and/or categorization). The task description 508 may be represented by a DAG (e.g., FIG. 6) and/or task action (FIG. 10).

According to the disclosure, the correction planner 518 may be configured to determine if the subtask may be completed based on the determined type of the error if the error is an incomplete subtask error. If the error type is an incorrect subtask error or omitted/skipped subtask error, the correction planner 518 may determine that a more detailed plan is needed to address the error.

According to the disclosure, the correction planner 518 may be configured to: (i) determine subtasks from a current state to an end state in the task description 508 (of executed or skipped subtasks; and (ii) invert the subtasks that were executed in inverted order (e.g., reversed edge directions). The task may define possible valid states of the workspace 118, which may include one or more elements (e.g., that are being assembled or disassembled) in the workspace 118. The uncertainty of the human can introduce unexpected current states (e.g., a tool over the motherboard, a memory inserted in the wrong slot, the wrong type of screw used, an unknown object in the workspace, etc.). According to the disclosure, phase (i) may include analyzing whether it is possible to create a path of subtasks (e.g., a solution from current (and “not-defined-by-the-task” state) to a start/end state of a subtask). For example, in the case of an unknown object (e.g., coffee mug of human operator) lying over the motherboard, phase (i) could include a requirement to remove the unknown object. This task is an unknown task and would fall into the unknown error category (e.g. “Ask operator for recovery” as described below). As another example, if a memory is inserted in the wrong slot (e.g., a memory slot that is not to be used), the cobot 102 may remove the memory from the improper slot and then insert it in the right slot (or remove it from the table).

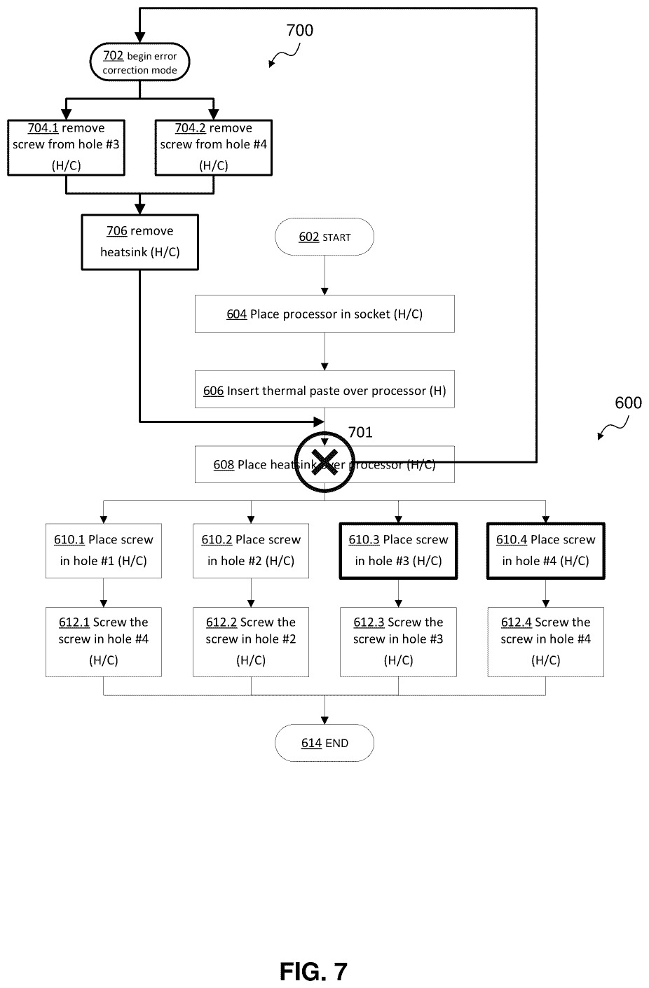

The correction planner 518 then adds a temporary set of subtasks to the task description 508 to be executed by the cobot 102. The temporary set of subtasks may be determined and added to the task description 508, 1000 as follows: an initial “begin error correction mode” subtask is added, which precedes the root subtasks in phase (i) (e.g., the determined subtasks from a current state to an end state in the task description 508); the latter is connected to (and preceding) all the root subtasks in phase (ii); the leaf subtasks is then connected to the earlier subtask that needs to be corrected. In this configuration, a root subtask is a subtask that has no precedence in a DAG. That is, the error correction mode may have the following sequence: (1) “begin error correction mode” node (e.g. operation 702 of FIG. 7); (2) (a) the root node from subtasks of phase (i); (2) (b) any leaf subtask(s) in phase (i); (3) (a) root node(s) from subtasks in phase (ii) (e.g. operations 704); (3) (b) any leaf subtask(s) from phase (ii) (e.g., operation 706); and (4) node in original task (e.g., operation 608 in FIG. 7). State differently, the error correction mode may have the following sequence: “begin error correction mode” node>the root node from subtasks of phase (i)>any leaf subtask(s) in phase (i)>root node(s) from subtasks in phase (ii)>(3) (b) any leaf subtask(s) from phase (ii)>(4) node in original task. In this example, “>” represents a connection between preceding node(s) to a subsequent node(s). According to the disclosure, if another error occurs during the correction, this other error will be detected during the execution of the correction subtasks and the plan is the corrected.

According to the disclosure, the correction planner 518 may be additionally configured to evaluate whether the error is recoverable or not (e.g., is there a plan to solve this error?). If an unrecoverable error is detected (NO at operation 520) and a feasible plan cannot be determined, the correction planner 518 may add an “Ask operator for recovery” subtask that stalls the cobot 102 until the human operator 116 resolves the error. During this subtask, the correction planner 518 may communicate with the human operator 116 to guide the human operator 116 in solving the problem. Once this subtask is finished by the human operator 116, the general state of the task in the cobot 102 is updated allowing the system to detect further errors and their corrections.

With reference to FIGS. 6 and 7, an example error is described, where FIG. 7 illustrates the insertion of the temporary subtask (leaf subtask) 700 to correct the error. In this example, consider the error 701 when the human operator 116 inserts the heatsink (at subtask 608) in the wrong direction, and places a screw in hole #4, and a screw in hole #3 (at subtask 610). As shown in FIG. 7, the initial error occurs when subtasks 610.3 and 610.4 are performed without a successful completion of subtask 608, which is indicated by the X mark. The subsequent subtasks (e.g. 610.3 and 610.4) that will require inversion are emphasis by bold borders.

At this point the system detects the error and identifies the error as an incorrect subtask error (operation 516 in FIG. 5). The correction planner 518 may determine the state of the environment, and based on this environmental determination, determines that no subtasks are required for phase (i). The correction planner 518 may then perform phase (ii), including inverting one or more subtasks (e.g., reversed edge directions). For example, the correction planner 518 may determining that the screws in holes #3 and #4 need to be removed, followed by the removal of the heatsink. The inverted subtasks include: 1) remove screws in holes #3 and #4 (inverted subtasks 704.1 and 704.2); and 2) remove the heatsink (inverted subtask 706). The inverted subtasks 702, 704, and 706 may then be added to the DAG of the task description temporarily as shown in FIG. 7. These inverted subtasks may have a higher priority, be communicated to the human operator 116, and precede the remaining of the subtasks in the DAG to ensure correctness. According to the disclosure, the correction planner 516 may adjust the executable actor (as defined in the task description, DAG) for one or more subtasks based on the error detection and correction. For example, because the human operator 116 incorrectly placed the heatsink in the example illustrated in FIG. 7, the correction planner 516 may modify who is allowed to perform the subtask 608 following the operations in the correction flow 700. In this example, the placement of the heatsink could be performed by either the human operator 116 or the cobot 102 (as reflected by the dual executable identifiers—“H/C”). The correction planner 516 may restrict this subtask to be performed only by the cobot 102 (following the removal at operation 706) to avoid a possible repeated incorrect placement of the heatsink by the human operator 116, for example.

In another example, the situation when an additional error results during the correction operations is discussed in more detail as follows. For example, when the human operator 116 removes the misplaced heatsink, consider the situation where the removal of the heatsink also removes the underlying processor due to the thermal paste between the processor and the heatsink. In this case, after the heatsink is removed, the environmental state would differ from the expected state (e.g., that the heatsink is removed and the processor and thermal paste remain correctly positioned). In this example, the system would detect another error (e.g., by comparing the currently detected state to the expected state), as it expects to have the processor and thermal paste reflecting the expected state describing the state. This detected error would then trigger the correction planner 518 to correct the error before the original task resumes. This second error correction would indicate two tasks are missing (“place processor” and “insert thermal paste”), resulting in the error detector 516 determining a “skipped subtask error” has occurred. In this case, the correction planner 518 may determine a possible valid state in phase (i) and there is no need for a correction. In this example, after removing the heat sink with the processor and thermal paste therebetween, the current state matches the start state (e.g., subtask 608 to place the processor). Therefore, because there is no need to plan for special subtask or to invert one or more subtasks, a valid state is determined (e.g., current state after removal equals the start state to place the processor at subtask 604) and phase (i) is not applicable. Phase (ii) discovered two skipped subtasks and corrects the skipped subtask error by adding no inverted subtasks (because no incorrect subtasks require to be undone as the screws and heatsink were previously removed during the previous correction) and connecting the “Begin Error correction mode” preceding subtask 604 “Place processor in socket.” The error correction execution would begin and immediately be finished by a correction in the internal state update.

Turning back to FIG. 5, based on the correction planning operations, the correction planner 518 may determine if the error is correctable (e.g., a path to correction is possible) by the cobot 102 at operation 520. If the error is not correctable (NO at operation 520), the flowchart 500 transitions to operation 530, where the system may generate a warning to notify the human operator 116 and/or one or more other components of the system and/or environment that an uncorrectable (e.g., by the cobot) error has occurred. This warning may indicate that the system is unable to determine a correction path for the cobot 102 to correct the path and that the system is unable to determine a suggest course of action for the human operator 116 to take to correct the error. After operation 530, the flowchart transitions to operation 514, where it is determined if the task has been completed.

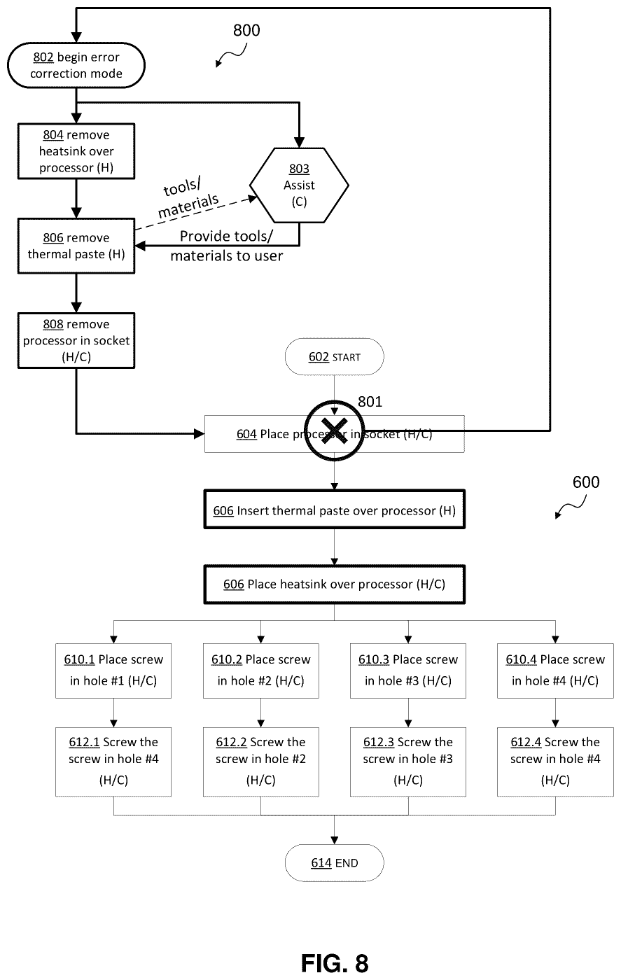

If the error is correctable (YES at operation 520), the flowchart 500 transitions to operation 522, where the system determines (e.g., by facilitator 522) a facilitation plan, which may include whether there are one or more subtasks in which the cobot 102 may assist the human operator 116 in the correction of the error (e.g., in cases where the human operator 116 performs the correction). That is, the system may determine if the cobot may facilitate in the error correction by assisting the human in the human's performance of the in the error correction. The facilitation plan may include one or more facilitation subtasks (e.g., assist 414 in FIG. 4, assist 803 in FIG. 8) that are configured to assist the human operator 116 in their performance of one or more corrective actions to correct the error. The determination of the facilitation plan may be based on the task description 508, the result of the correction planning, the detected error, and/or the determination of the correctability of the detected error. The task description 508 may be represented by a DAG (e.g., FIG. 6) and/or task action (FIG. 10).

This determination is illustrated in the flowchart at operation 522, where facilitation processing is performed to determine if the cobot may facilitate in the correcting the error (e.g., assist the human operator 116 in their actions to correct the error) and/or if the cobot may directly take actions to correct the error itself. The assisting by the cobot 102 in the correction of the error is illustrated with reference to FIG. 8, and discussed in more detail below.

The flowchart 500 then transitions to operation 524, where it is determined whether the cobot 102 may either correct the error itself or facilitate in the error correction by assisting the human in the error correction. For example, if the cobot cannot correct a detected error, the cobot 102 may facilitate its correction by assisting the human operator 116 in the correction.

If cobot correction and/or facilitation is possible (NO at operation 524), the flowchart transitions to operation 530, where where the system may generate a warning to notify the human operator 116 and/or one or more other components of the system and/or environment that an uncorrectable error has occurred. After operation 530, the flowchart transitions to operation 514, where it is determined if the task has been completed.

If cobot correction and/or facilitation is possible (YES at operation 524), the flowchart 500 transitions to operation 526, where the correction plan is communicated to the human operator 116 to notify the human operator 116 of the intended correction plan. This communication may include a notification that the cobot intends to correct the error and the operation(s) that will be performed by the cobot 102 to correct the error, or a notification that the cobot in unable to correct the error by itself as well as facilitation information (e.g., the cobot's operations that will be performed to assist the human operator 116) that describes the operations that the cobot 102 may perform to assist the human operator 116 in their error correction operations.

The flowchart 500 then transitions to operation 528, where the correction plan (e.g., direct cobot correction or human correction with cobot assistance) is executed to correct the error. If the cobot 102 is to correct the error itself, the cobot 102 may correct the error as described above with reference to FIGS. 6 and 7. The flowchart 500 then transitions to operation 514.

If the human operator 116 is to correct the error and the cobot 102 is unable to assist the human operator 116, the cobot 102 may remain idle until the human operator 116 resolves and corrects the error (e.g., until the decision at operation 514 is made).

After operation 528, the flowchart 500 transitions to operation 514, where it is determined if the task is complete. That is, the system may check is all subtasks of the task have been completed. If not (e.g., one or more subtasks remain), the flowchart 500 returns to operation 502, where additional sensor data is captured and the process may be repeated for the remaining subtask(s). In this configuration, the operations 502, 504, 506, 510, 512, and 514 form a sense-update-act loop, where the loop me be iteratively performed until the task is complete. If there are no remaining subtasks, the flowchart 500 transitions to operation 532, where the flowchart 500 ends.

Turning back to operations 522, 524, and 528, FIG. 8 illustrates the facilitation operation by the cobot 102, according to the disclosure, to assist the human operator 116 in the correction of the error. In this example, consider the error 801 when the human operator 116 inserts the processor incorrectly. The subsequent subtasks (e.g. 604 and 606) that will require inversion are emphasis by bold borders. FIG. 8 illustrates the insertion of the temporary subtask (leaf subtask) 800 to correct the error, as well as to facilitate the error correction by the cobot 102 (e.g., assistance at operation 803). In this example, the temporary subtask 800 includes the operation 802 (“begin error correction mode”), followed by the inverted subtasks, which include: 1) remove the heatsink (inverted subtask 804); 2) remove the thermal paste (inverted subtask 808); and 3) remove the processor (inverted subtask 808), and the assist subtask 803.

At this point the system detects the error and identifies the error as an incorrect subtask error (operation 516 in FIG. 5). The correction planner 518 may determine the state of the environment, and based on this environmental determination, determines that no subtasks are required for phase (i). The correction planner 518 may then perform phase (ii), including inverting one or more subtasks (e.g., reversed edge directions). For example, the correction planner 518 may determining that the heat sink needs to be removed, followed by the removal of the thermal paste, and then the removal of the incorrectly placed processor. The inverted subtasks include: 1) remove the heatsink (inverted subtask 804); 2) remove the thermal paste (inverted subtask 808); and 3) remove the processor (inverted subtask 808). The inverted subtasks 804, 806, and 808 may then be added to the DAG of the task description temporarily as shown in FIG. 8. These inverted subtasks may have a higher priority, be communicated to the human operator 116, and precede the remaining of the subtasks in the DAG to ensure correctness.

According to the disclosure, tool(s) and atomic actions necessary to complete a task describe each subtask (see FIG. 10, fields 1004 and 1006). If both descriptions 1004 and 1006 are empty, and/or the cobot executable field 1016 is empty or in the negative, only the human operator 116 can perform the subtask. On the other hand, if atomic actions 1004 are present in the subtask (as reflected in the subtask action 1000), both the human operator 116 and the cobot 102 may perform the subtask (e.g., the cobot 102 uses the atomic actions to complete the subtask). If the subtask is a human subtask, the identification of tools and/or materials (the task description at field 1006), the cobot 102 may assist the human operator 116 by, for example, providing the tools or materials described in the subtask structure (subtask action 1000 at field 1006).

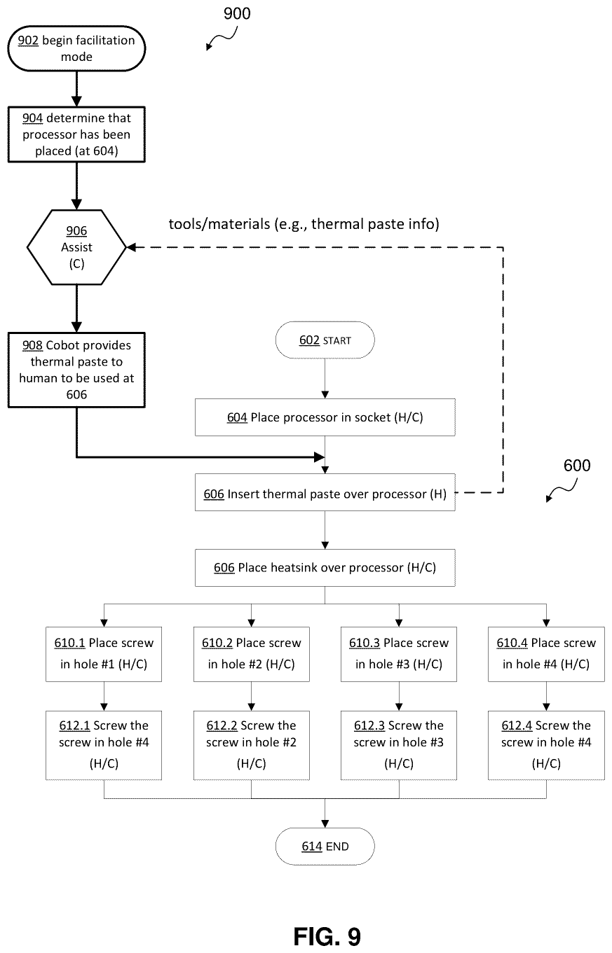

In the DAG task action 600, the subtask 606 to “insert thermal paste over the processor,” include the execution denier (H), denoting that this subtask is only performable by the human operator 116. Similarly, the subtask action for the subtask 606 may further include an empty field for atomic actions (e.g. atomic actions DAG 1004 as shown in FIG. 10), which also denotes that the cobot 102 cannot perform this subtask. Because the subtask is performable by the human operator 116, the inverse subtask (e.g. inverse subtask 1012) is also performable by the human operator 116, and may be defined by “remove thermal paste.” According to the disclosure, the tools/materials information (e.g., set of external tools/materials 1006 in the task description) may define tools and/or materials to perform the subtask and/or inverse subtask. In this example, the tools/materials information may include a thermal paste dependency that may include an identified thermal paste to be used for the subtask 606 and/or one or more tools that may be used to apply and/or remove the thermal paste. Not only may this information be communicated to the human operator 116 to assist them in the subtask 606 (and/or the inverse 806), the cobot 102 can leverage this information to assist the human operator 116 in the performance of the subtask (see FIG. 9) and/or performance of the inverse subtask 806. For example, the temporary subtask (leaf subtask) 800 may include an assist operation 803 that is configured to accesses the tools/materials information from inverse subtask 806 (and/or subtask 606). Using this information, the assist subtask 803, which may be performed by the facilitator 522, may provide the human operator 116 with one or more tools and/or materials that may be used to remove the thermal paste. For example, the cobot 102 may pick up the thermal paste and provide it to the human operator 116 to assist the human operator 116. By accessing the inverse subtask 806 (and/or subtask 606), the assist subtask 803 may include (e.g., in its task description) the same tools/materials as the inverse subtask 806, as well as atomic actions that include grasping and motion primitives to pick up and provide the thermal paste to the human operator 116.

FIG. 9 illustrates a facilitation operation similar to the facilitation of the error correction described with reference to FIG. 8. In this example, the assistance performed by the cobot 102 is used in the course of the task performance outside of error correction operations. That is, the cobot 102 may be configured to assist the human operator 116 to perform subtasks in addition to assisting in error correction. In the example illustrated, the facilitation mode 900 is performed to assist the human operator 116 in the performance of subtask 606 (“insert thermal paste over processor”). The facilitation mode 900 includes subtask 902, which begins the facilitation mode. Subtask 904 is then performed to determine (e.g., confirm) that the subtask 604 has been completed. Then the assist subtask 906 is performed, which accesses the tools and/or materials information from the subtask 606. In this example, this information may include the appropriate thermal paste that should be used for subtask 606. Using this information, the cobot 102 may obtain the thermal paste and provide the thermal paste to the human operator 116 at subtask 908 to assist the human's application of the thermal paste at subtask 606.

### EXAMPLES

The following examples pertain to various techniques of the present disclosure.
An example (e.g., example 1) relates to a control device, comprising: an error detector configured to detect an error in a performance of a human-robot collaborative task; and an error corrector including: correction planner configured to determine an error correction plan based on the detected error, the error correction plan including one or more corrective subtasks configured to control a collaborative robot (cobot) to correct the detected error; and a facilitator configured to determine a facilitation plan based on the determined error correction plan, the facilitation plan including an assistance subtask configured to control the cobot to assist a human operator in correcting the detected error, wherein the error corrector is configured to generate a control signal to control the cobot based on the correction plan and the facilitation plan.
Another example (e.g., example 2) relates to a previously-described example (e.g., example 1), wherein the correction planner is configured to determine the error correction plan further based on a task description.
Another example (e.g., example 3) relates to a previously-described example (e.g., one or more of examples 1-2), wherein the facilitator is configured to determine the facilitation plan further based on a task description.
Another example (e.g., example 4) relates to a previously-described example (e.g., example 1), wherein the correction planner is configured to determine the error correction plan further based on a task description and the facilitator is configured to determine the facilitation plan further based on the task description.
Another example (e.g., example 5) relates to a previously-described example (e.g., example 4), wherein the task description comprises one or more subtask actions defining one or more respective subtasks of the human-robot collaborative task.
Another example (e.g., example 6) relates to a previously-described example (e.g., example 5), wherein the one or more subtask actions comprise: an inverse subtask configured to reverse a corresponding subtask of the human-robot collaborative task; an executable identifier indicative of whether the human operator and/or the cobot is configured to perform the corresponding subtask; and tool and/or material information defining one or more tools and/or materials usable to perform the corresponding subtask.
Another example (e.g., example 7) relates to a previously-described example (e.g., one or more of examples 1-6), wherein the control signal controls the cobot to perform the one or more corrective subtasks in response to the detected error being correctable by the cobot.
Another example (e.g., example 8) relates to a previously-described example (e.g., one or more of examples 1-7), wherein the control signal controls the cobot to perform the assistance subtask in response to cobot being unable to correct the detected error.
Another example (e.g., example 9) relates to a previously-described example (e.g., one or more of examples 1-8), wherein the one or more corrective subtasks includes one or more inverted subtasks configured to reverse one or more corresponding subtasks of the human-robot collaborative task.
An example (e.g., example 10) relates to a control device, comprising: one or more processors; and memory storing instructions that, when executed by the one or more processors, configure the control device to: detect an error in a performance of a human-robot collaborative task; determine an error correction plan, based on the detected error, configured to control a collaborative robot (cobot) to correct the detected error; determine a facilitation plan, based on the determined error correction plan, configured to control the cobot to assist a human operator in correcting the detected error; and generate a control signal to control the cobot based on the correction plan and the facilitation plan.
Another example (e.g., example 11) relates to a previously-described example (e.g., example 10), wherein the error correction plan includes one or more corrective subtasks configured to control the cobot to correct the detected error, and the facilitation plan includes an assistance subtask that is configured to control the cobot to assist the human operator in correcting the detected error.
Another example (e.g., example 12) relates to a previously-described example (e.g., example 11), wherein the one or more corrective subtasks includes one or more inverted subtasks configured to reverse one or more corresponding subtasks of the human-robot collaborative task.
Another example (e.g., example 13) relates to a previously-described example (e.g., one or more of examples 10-12), wherein determining the error correction plan is further based on a task description and determining the facilitation plan is further based on the task description.
Another example (e.g., example 14) relates to a previously-described example (e.g., example 13), wherein the task description comprises one or more subtask actions defining one or more respective subtasks of the human-robot collaborative task.
Another example (e.g., example 15) relates to a previously-described example (e.g., example 14), wherein the one or more subtask actions comprise: an inverse subtask configured to reverse a corresponding subtask of the human-robot collaborative task; an executable identifier indicative of whether the human operator and/or the cobot is configured to perform the corresponding subtask; and tool and/or material information defining one or more tools and/or materials usable to perform the corresponding subtask.
Another example (e.g., example 16) relates to a previously-described example (e.g., one or more of examples 10-15), wherein the control signal controls the cobot to: correct the detected error in response to the detected error being correctable by the cobot; and assist the human operator in their performance of one or more corrective actions to correct the detected error in response to cobot being unable to correct the detected error.
An example (e.g., example 17) relates to a collaborative robot (cobot), comprising: a movable manipulator arm configured to perform one or more subtasks of a human-robot collaborative task; and a controller configured to: detect an error in a performance of the human-robot collaborative task; determine an error correction plan based on the detected error, the error correction plan including one or more corrective subtasks configured to control the cobot to correct the detected error; determine a facilitation plan based on the determined error correction plan, the facilitation plan including an assistance subtask configured to control the cobot to assist a human operator in correcting the detected error; and generate a control signal to control the manipulator arm based on the correction plan and the facilitation plan.
Another example (e.g., example 18) relates to a previously-described example (e.g., example 17), wherein the detected error is an error performed by the human operator.
Another example (e.g., example 19) relates to a previously-described example (e.g., one or more of examples 17-18), wherein the controller is configured to detect the error based on a comparison of a detected end state of a workspace of the cobot following performance of the one or more subtasks and an expected end state of the workspace following the performance of the one or more subtasks.
Another example (e.g., example 20) relates to a previously-described example (e.g., one or more of examples 17-19), wherein the assistance subtask comprises providing, by the manipulator arm, a tool and/or one or more materials to the human operator to be used to perform a corrective action by the human operator.
An example (e.g., example 21) relates to a control device, comprising: error detection means for detecting an error in a performance of a human-robot collaborative task; and error correction means including: correction planning means for determining an error correction plan based on the detected error, the error correction plan including one or more corrective subtasks configured to control a collaborative robot (cobot) to correct the detected error; and facilitation means for determining a facilitation plan based on the determined error correction plan, the facilitation plan including an assistance subtask configured to control the cobot to assist a human operator in correcting the detected error, wherein the error corrector is configured to generate a control signal to control the cobot based on the correction plan and the facilitation plan.
Another example (e.g., example 22) relates to a previously-described example (e.g., example 21), wherein the correction planning means is configured to determine the error correction plan further based on a task description.
Another example (e.g., example 23) relates to a previously-described example (e.g., one or more of examples 21-22), wherein the facilitation means is configured to determine the facilitation plan further based on a task description.
Another example (e.g., example 24) relates to a previously-described example (e.g., example 21), wherein the correction planning means is configured to determine the error correction plan further based on a task description and the facilitation means is configured to determine the facilitation plan further based on the task description.
Another example (e.g., example 25) relates to a previously-described example (e.g., example 24), wherein the task description comprises one or more subtask actions defining one or more respective subtasks of the human-robot collaborative task.
Another example (e.g., example 26) relates to a previously-described example (e.g., example 25), wherein the one or more subtask actions comprise: an inverse subtask configured to reverse a corresponding subtask of the human-robot collaborative task; an executable identifier indicative of whether the human operator and/or the cobot is configured to perform the corresponding subtask; and tool and/or material information defining one or more tools and/or materials usable to perform the corresponding subtask.
Another example (e.g., example 27) relates to a previously-described example (e.g., one or more of examples 21-26), wherein the control signal controls the cobot to perform the one or more corrective subtasks in response to the detected error being correctable by the cobot.
Another example (e.g., example 28) relates to a previously-described example (e.g., one or more of examples 21-27), wherein the control signal controls the cobot to perform the assistance subtask in response to cobot being unable to correct the detected error.
Another example (e.g., example 29) relates to a previously-described example (e.g., one or more of examples 21-28), wherein the one or more corrective subtasks includes one or more inverted subtasks configured to reverse one or more corresponding subtasks of the human-robot collaborative task.
An example (e.g., example 30) relates to a control device, comprising: processing means; and memory storing means for storing instructions that, when executed by the processing means, configure the control device to: detect an error in a performance of a human-robot collaborative task; determine an error correction plan, based on the detected error, configured to control a collaborative robot (cobot) to correct the detected error; determine a facilitation plan, based on the determined error correction plan, configured to control the cobot to assist a human operator in correcting the detected error; and generate a control signal to control the cobot based on the correction plan and the facilitation plan.
Another example (e.g., example 31) relates to a previously-described example (e.g., example 30), wherein the error correction plan includes one or more corrective subtasks configured to control the cobot to correct the detected error, and the facilitation plan includes an assistance subtask that is configured to control the cobot to assist the human operator in correcting the detected error.
Another example (e.g., example 33) relates to a previously-described example (e.g., example 31), wherein the one or more corrective subtasks includes one or more inverted subtasks configured to reverse one or more corresponding subtasks of the human-robot collaborative task.
Another example (e.g., example 33) relates to a previously-described example (e.g., one or more of examples 30-32), wherein determining the error correction plan is further based on a task description and determining the facilitation plan is further based on the task description.
Another example (e.g., example 34) relates to a previously-described example (e.g., example 33), wherein the task description comprises one or more subtask actions defining one or more respective subtasks of the human-robot collaborative task.
Another example (e.g., example 35) relates to a previously-described example (e.g., example 34), wherein the one or more subtask actions comprise: an inverse subtask configured to reverse a corresponding subtask of the human-robot collaborative task; an executable identifier indicative of whether the human operator and/or the cobot is configured to perform the corresponding subtask; and tool and/or material information defining one or more tools and/or materials usable to perform the corresponding subtask.
Another example (e.g., example 36) relates to a previously-described example (e.g., one or more of examples 30-35), wherein the control signal controls the cobot to: correct the detected error in response to the detected error being correctable by the cobot; and assist the human operator in their performance of one or more corrective actions to correct the detected error in response to cobot being unable to correct the detected error.
An example (e.g., example 37) relates to a collaborative robot (cobot), comprising: manipulation means for performing one or more subtasks of a human-robot collaborative task; and control means for: detecting an error in a performance of the human-robot collaborative task; determine an error correction plan based on the detected error, the error correction plan including one or more corrective subtasks configured to control the cobot to correct the detected error; determining a facilitation plan based on the determined error correction plan, the facilitation plan including an assistance subtask configured to control the cobot to assist a human operator in correcting the detected error; and generating a control signal to control the manipulator arm based on the correction plan and the facilitation plan.
Another example (e.g., example 38) relates to a previously-described example (e.g., example 37), wherein the detected error is an error performed by the human operator.
Another example (e.g., example 39) relates to a previously-described example (e.g., one or more of examples 37-38), wherein the control means is configured to detect the error based on a comparison of a detected end state of a workspace of the cobot following performance of the one or more subtasks and an expected end state of the workspace following the performance of the one or more subtasks.
Another example (e.g., example 40) relates to a previously-described example (e.g., one or more of examples 37-39), wherein the assistance subtask comprises providing, by the manipulator arm, a tool and/or one or more materials to the human operator to be used to perform a corrective action by the human operator.
Another example (e.g., example 41) relates to an autonomous agent comprising the controller of a previously-described example (e.g., one or more of examples 1-16 and 21-36).
Another example (e.g., example 42) relates to a previously-described example (e.g., example 41), wherein the autonomous agent is an autonomous mobile robot.
Another example (e.g., example 43) relates to a previously-described example (e.g., example 41), wherein the autonomous agent is a collaborative robot (cobot).
Another example (e.g., example 44) relates to non-transitory computer-readable storage medium with an executable program stored thereon, that when executed, instructs a processor to perform a method as shown and described.
Another example (e.g., example 45) relates to an autonomous agent as shown and described.
Another example (e.g., example 46) relates to collaborative robot (cobot) as shown and described.
Another example (e.g., example 47) relates to an apparatus as shown and described. Another example (e.g., example 48) relates a method as shown and described.

### CONCLUSION

The aforementioned description will so fully reveal the general nature of the implementation of the disclosure that others can, by applying knowledge within the skill of the art, readily modify and/or adapt for various applications such specific implementations without undue experimentation and without departing from the general concept of the present disclosure. Therefore, such adaptations and modifications are intended to be within the meaning and range of equivalents of the disclosed implementations, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Each implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to affect such feature, structure, or characteristic in connection with other implementations whether or not explicitly described.

The exemplary implementations described herein are provided for illustrative purposes, and are not limiting. Other implementations are possible, and modifications may be made to the exemplary implementations. Therefore, the specification is not meant to limit the disclosure. Rather, the scope of the disclosure is defined only in accordance with the following claims and their equivalents.

The designs of the disclosure may be implemented in hardware (e.g., circuits), firmware, software, or any combination thereof. Designs may also be implemented as instructions stored on a machine-readable medium, which may be read and executed by one or more processors. A machine-readable medium may include any mechanism for storing or transmitting information in a form readable by a machine (e.g., a computing device). A machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general-purpose computer.

Throughout the drawings, it should be noted that like reference numbers are used to depict the same or similar elements, features, and structures, unless otherwise noted.

The terms “at least one” and “one or more” may be understood to include a numerical quantity greater than or equal to one (e.g., one, two, three, four, [ . . . ], etc.). The term “a plurality” may be understood to include a numerical quantity greater than or equal to two (e.g., two, three, four, five, [ . . . ], etc.).

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. The terms “group (of)”, “set (of)”, “collection (of)”, “series (of)”, “sequence (of)”, “grouping (of)”, etc., and the like in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The phrase “at least one of” with regard to a group of elements may be used herein to mean at least one element from the group consisting of the elements. The phrase “at least one of” with regard to a group of elements may be used herein to mean a selection of: one of the listed elements, a plurality of one of the listed elements, a plurality of individual listed elements, or a plurality of a multiple of individual listed elements.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned data types and may take various forms and represent any information as understood in the art.

The terms “processor,” “processing circuitry,” or “controller” as used herein may be understood as any kind of technological entity that allows handling of data. The data may be handled according to one or more specific functions executed by the processor, processing circuitry, or controller. Further, processing circuitry, a processor, or a controller as used herein may be understood as any kind of circuit, e.g., any kind of analog or digital circuit. Processing circuitry, a processor, or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as processing circuitry, a processor, controller, or logic circuit. It is understood that any two (or more) of the processors, controllers, logic circuits, or processing circuitries detailed herein may be realized as a single entity with equivalent functionality or the like, and conversely that any single processor, controller, logic circuit, or processing circuitry detailed herein may be realized as two (or more) separate entities with equivalent functionality or the like.

As used herein, “memory” is understood as a computer-readable medium in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, among others, or any combination thereof. Registers, shift registers, processor registers, data buffers, among others, are also embraced herein by the term memory. The term “software” refers to any type of executable instruction, including firmware.

In one or more of the implementations described herein, processing circuitry can include memory that stores data and/or instructions. The memory can be any well-known volatile and/or non-volatile memory, including read-only memory (ROM), random access memory (RAM), flash memory, a magnetic storage media, an optical disc, erasable programmable read only memory (EPROM), and programmable read only memory (PROM). The memory can be non-removable, removable, or a combination of both.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). Processing circuitry, a processor, or a controller may transmit or receive data over a software-level connection with another processor, controller, or processing circuitry in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving. i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

An “agent” may be understood to include any type of driven object. An agent may be a driven object with a combustion engine, a reaction engine, an electrically driven object, a hybrid driven object, or a combination thereof. An agent may be or may include a moving robot, a personal transporter, a drone, and the like.

The term “autonomous agent” may describe an agent that implements all or substantially all navigational changes, at least during some (significant) part (spatial or temporal, e.g., in certain areas, or when ambient conditions are fair, or on highways, or above or below a certain speed) of some drives. Sometimes an “autonomous agent” is distinguished from a “partially autonomous agent” or a “semi-autonomous agent” to indicate that the agent is capable of implementing some (but not all) navigational changes, possibly at certain times, under certain conditions, or in certain areas. A navigational change may describe or include a change in one or more of steering, braking, or acceleration/deceleration of the agent. An agent may be described as autonomous even in case the agent is not fully automatic (fully operational with driver or without driver input). Autonomous agents may include those agents that can operate under driver control during certain time periods and without driver control during other time periods. Autonomous agents may also include agents that control only some implementations of agent navigation, such as steering (e.g., to maintain an agent course between agent lane constraints) or some steering operations under certain circumstances (but not under all circumstances), but may leave other implementations of agent navigation to the driver (e.g., braking or braking under certain circumstances). Autonomous agents may also include agents that share the control of one or more implementations of agent navigation under certain circumstances (e.g., hands-on, such as responsive to a driver input) and agents that control one or more implementations of agent navigation under certain circumstances (e.g., hands-off, such as independent of driver input). Autonomous agents may also include agents that control one or more implementations of agent navigation under certain circumstances, such as under certain environmental conditions (e.g., spatial areas, roadway conditions). In some implementations, autonomous agents may handle some or all implementations of braking, speed control, velocity control, and/or steering of the agent. An autonomous agent may include those agents that can operate without a driver. The level of autonomy of an agent may be described or determined by the Society of Automotive Engineers (SAE) level of the agent (as defined by the SAE in SAE J3016 2018: Taxonomy and definitions for terms related to driving automation systems for on road motor vehicles) or by other relevant professional organizations. The SAE level may have a value ranging from a minimum level, e.g., level 0 (illustratively, substantially no driving automation), to a maximum level, e.g., level 5 (illustratively, full driving automation).

The systems and methods of the disclosure may utilize one or more machine learning models to perform corresponding functions of the agent (or other functions described herein). The term “model” as, for example, used herein may be understood as any kind of algorithm, which provides output data from input data (e.g., any kind of algorithm generating or calculating output data from input data). A machine learning model may be executed by a computing system to progressively improve performance of a specific task. According to the disclosure, parameters of a machine learning model may be adjusted during a training phase based on training data. A trained machine learning model may then be used during an inference phase to make predictions or decisions based on input data.

The machine learning models described herein may take any suitable form or utilize any suitable techniques. For example, any of the machine learning models may utilize supervised learning, semi-supervised learning, unsupervised learning, or reinforcement learning techniques.

In supervised learning, the model may be built using a training set of data that contains both the inputs and corresponding desired outputs. Each training instance may include one or more inputs and a desired output. Training may include iterating through training instances and using an objective function to teach the model to predict the output for new inputs. In semi-supervised learning, a portion of the inputs in the training set may be missing the desired outputs.

In unsupervised learning, the model may be built from a set of data which contains only inputs and no desired outputs. The unsupervised model may be used to find structure in the data (e.g., grouping or clustering of data points) by discovering patterns in the data. Techniques that may be implemented in an unsupervised learning model include, e.g., self-organizing maps, nearest-neighbor mapping, k-means clustering, and singular value decomposition.

Reinforcement learning models may be given positive or negative feedback to improve accuracy. A reinforcement learning model may attempt to maximize one or more objectives/rewards. Techniques that may be implemented in a reinforcement learning model may include, e.g., Q-learning, temporal difference (TD), and deep adversarial networks.

The systems and methods of the disclosure may utilize one or more classification models. In a classification model, the outputs may be restricted to a limited set of values (e.g., one or more classes). The classification model may output a class for an input set of one or more input values. An input set may include road condition data, event data, sensor data, such as image data, radar data, LIDAR data and the like, and/or other data as would be understood by one of ordinary skill in the art. A classification model as described herein may, for example, classify certain driving conditions and/or environmental conditions, such as weather conditions, road conditions, and the like. References herein to classification models may contemplate a model that implements, e.g., any one or more of the following techniques: linear classifiers (e.g., logistic regression or naive Bayes classifier), support vector machines, decision trees, boosted trees, random forest, neural networks, or nearest neighbor.

One or more regression models may be used. A regression model may output a numerical value from a continuous range based on an input set of one or more values. References herein to regression models may contemplate a model that implements, e.g., any one or more of the following techniques (or other suitable techniques): linear regression, decision trees, random forest, or neural networks.

A machine learning model described herein may be or may include a neural network. The neural network may be any kind of neural network, such as a convolutional neural network, an autoencoder network, a variational autoencoder network, a sparse autoencoder network, a recurrent neural network, a deconvolutional network, a generative adversarial network, a forward-thinking neural network, a sum-product neural network, and the like. The neural network may include any number of layers. The training of the neural network (e.g., adapting the layers of the neural network) may use or may be based on any kind of training principle, such as backpropagation (e.g., using the backpropagation algorithm).

As described herein, the following terms may be used as synonyms: driving parameter set, driving model parameter set, safety layer parameter set, driver assistance, automated driving model parameter set, and/or the like (e.g., driving safety parameter set). These terms may correspond to groups of values used to implement one or more models for directing an agent to operate according to the manners described herein. Furthermore, throughout the present disclosure, the following terms may be used as synonyms: driving parameter, driving model parameter, safety layer parameter, driver assistance and/or automated driving model parameter, and/or the like (e.g., driving safety parameter), and may correspond to specific values within the previously described sets.

1. A control device, comprising:
an error detector configured to detect an error in a performance of a human-robot collaborative task; and
an error corrector including:
correction planner configured to determine an error correction plan based on the detected error, the error correction plan including one or more corrective subtasks configured to control a collaborative robot (cobot) to correct the detected error; and
a facilitator configured to determine a facilitation plan based on the determined error correction plan, the facilitation plan including an assistance subtask configured to control the cobot to assist a human operator in correcting the detected error,
wherein the error corrector is configured to generate a control signal to control the cobot based on the correction plan and the facilitation plan.

2. The control device of claim 1, wherein the correction planner is configured to determine the error correction plan further based on a task description.

3. The control device of claim 1, wherein the facilitator is configured to determine the facilitation plan further based on a task description.

4. The control device of claim 1, wherein the correction planner is configured to determine the error correction plan further based on a task description and the facilitator is configured to determine the facilitation plan further based on the task description.

5. The control device of claim 4, wherein the task description comprises one or more subtask actions defining one or more respective subtasks of the human-robot collaborative task.

6. The control device of claim 5, wherein the one or more subtask actions comprise:
an inverse subtask configured to reverse a corresponding subtask of the human-robot collaborative task;
an executable identifier indicative of whether the human operator and/or the cobot is configured to perform the corresponding subtask; and
tool and/or material information defining one or more tools and/or materials usable to perform the corresponding subtask.

7. The control device of claim 1, wherein the control signal controls the cobot to perform the one or more corrective subtasks in response to the detected error being correctable by the cobot.

8. The control device of claim 1, wherein the control signal controls the cobot to perform the assistance subtask in response to cobot being unable to correct the detected error.

9. The control device of claim 1, wherein the one or more corrective subtasks includes one or more inverted subtasks configured to reverse one or more corresponding subtasks of the human-robot collaborative task.

10. A control device, comprising:
one or more processors; and
memory storing instructions that, when executed by the one or more processors, configure the control device to:
detect an error in a performance of a human-robot collaborative task;
determine an error correction plan, based on the detected error, configured to control a collaborative robot (cobot) to correct the detected error;
determine a facilitation plan, based on the determined error correction plan, configured to control the cobot to assist a human operator in correcting the detected error; and
generate a control signal to control the cobot based on the correction plan and the facilitation plan.

11. The control device of claim 10, wherein the error correction plan includes one or more corrective subtasks configured to control the cobot to correct the detected error, and the facilitation plan includes an assistance subtask that is configured to control the cobot to assist the human operator in correcting the detected error.

12. The control device of claim 11, wherein the one or more corrective subtasks includes one or more inverted subtasks configured to reverse one or more corresponding subtasks of the human-robot collaborative task.

13. The control device of claim 10, wherein determining the error correction plan is further based on a task description and determining the facilitation plan is further based on the task description.

14. The control device of claim 13, wherein the task description comprises one or more subtask actions defining one or more respective subtasks of the human-robot collaborative task.

15. The control device of claim 14, wherein the one or more subtask actions comprise:
an inverse subtask configured to reverse a corresponding subtask of the human-robot collaborative task;
an executable identifier indicative of whether the human operator and/or the cobot is configured to perform the corresponding subtask; and
tool and/or material information defining one or more tools and/or materials usable to perform the corresponding subtask.

16. The control device of claim 10, wherein the control signal controls the cobot to:
correct the detected error in response to the detected error being correctable by the cobot; and
assist the human operator in their performance of one or more corrective actions to correct the detected error in response to cobot being unable to correct the detected error.

17. A collaborative robot (cobot), comprising:
a movable manipulator arm configured to perform one or more subtasks of a human-robot collaborative task; and
a controller configured to:
detect an error in a performance of the human-robot collaborative task;
determine an error correction plan based on the detected error, the error correction plan including one or more corrective subtasks configured to control the cobot to correct the detected error;
determine a facilitation plan based on the determined error correction plan, the facilitation plan including an assistance subtask configured to control the cobot to assist a human operator in correcting the detected error; and
generate a control signal to control the manipulator arm based on the correction plan and the facilitation plan.

18. The cobot of claim 17, wherein the detected error is an error performed by the human operator.

19. The cobot of claim 17, wherein the controller is configured to detect the error based on a comparison of a detected end state of a workspace of the cobot following performance of the one or more subtasks and an expected end state of the workspace following the performance of the one or more subtasks.

20. The cobot of claim 17, wherein the assistance subtask comprises providing, by the manipulator arm, a tool and/or one or more materials to the human operator to be used to perform a corrective action by the human operator.
